(19) United States
(12) Patent Application Publication
(10) Pub. No.: US 2025/0062420 A1
(43) Pub. Date: Feb. 20, 2025

(54) Electrolyte Additives and Rechargeable Batteries Comprising the Same

(71) Applicant: City University of Hong Kong, Kowloon (HK)

(72) Inventors: Yau Wai Denis Yu, Mid-Level (HK); Qiaohui Duan, Sham Shui Po (HK)

(21) Appl. No.: 18/804,619

(22) Filed: Aug. 14, 2024

Related U.S. Application Data
(60) Provisional application No. 63/519,604, filed on Aug. 15, 2023.

(51) Int. Cl. H01M 10/36; H01M 4/02; H01M 4/42; H01M 4/50

(52) U.S. Cl. CPC H01M 10/36; H01M 4/42; H01M 4/50; H01M 2004/027; H01M 2004/028; H01M 2300/0002

(57) ABSTRACT

An electrolyte for a battery having a manganese-based cathode includes a metal/metalloid ion of the formula Mⁿ⁺ where M indicates a metal/metalloid and wherein n is from about 2 to about 4. A battery having a manganese-based cathode includes the electrolyte as described; or wherein the electrolyte includes from about 0.05% (w/v) to about 10% (w/v); or from about 0.1% (w/v) to about 5% (w/v), metal/metalloid ion. A battery including the electrolyte and a method for improving performance of the battery are provided. A method for improving performance of a battery including a manganese-based cathode includes introducing a metal/metalloid ion of the formula Mⁿ⁺ where M indicates a metal/metalloid and wherein n is from about 2 to about 4 into an electrolyte.

### FIELD OF THE INVENTION

This application relates to electrolyte additives for rechargeable manganese-zinc battery.

### BACKGROUND

Rechargeable aqueous manganese-zinc battery is a promising candidate to replace commercial lead-acid batteries, featuring the intrinsic safety, low cost, low toxicity, and moderate energy density. However, the poor cycle stability is the main hinderance to the practical application of rechargeable manganese-zinc battery, especially with a higher utilization of capacity, such as >200 mAh g⁻¹. Specifically, during cycling, the MnO₂ cathode will undergo irreversible phase transformation into electrochemically inert phases, such as ZnMn₂O₄, and ZnMn₃O₇. These Zn-contained phases are stable and Zn ions can hardly be released. Consequently, the active cathode material is gradually consumed, leading to decrease in capacity with cycling.

In a traditional manganese-zinc battery, different kinds of MnO₂ polymorphs are typically used as the cathode, and Zn foil is typically used as anode. Aqueous 1M ZnSO₄+0.1M MnSO₄ liquid may be used as the electrolyte. This typical configuration is illustrated in FIG. 1.

This aqueous system can achieve a capacity of about 300 mAh g⁻¹. During the discharging process, MnO₂ undergoes a proton insertion reaction (Eq. 1) along with MnO₂ dissolution (Eq. 2):

MnO₂+H⁺+e⁻→HMnO₂(s) (Eq. 1)

MnO₂+4H⁺+2e⁻→Mn²⁺(l)+2H₂O (Eq. 2)

During the charging process, the proton is released and MnO₂ deposition occurs as reversible reactions of Eq. 1 and Eq. 2. However, side reactions, such as the simultaneous Zn²⁺ incorporation into the MnO₂ cathode will also typically occur (Eq. 3):

2Mn²⁺+Zn²⁺+8OH−→ZnMn₂O₄+4H₂O+2e⁻ (Eq. 3)

Apart from ZnMn₂O₄, sometimes we can also find ZnMn₃O₇ phase. The phase change is not obvious within a short cycle life, but these ZnₓMn_{y}O phases are found to accumulate after long-term cycling. These phases are electrochemical inactive and thus will gradually consume the active MnO₂ cathode, leading to battery capacity decrease (FIG. 2). Meanwhile, these phases will also increase the electrode resistance and hinder the ion transfer.

Additives are frequently added to electrolytes of other battery systems such as lithium-ion, Li—S, Li metal batteries in order to improve battery performances, such as cycle performance. The additives are usually organic-based such as solvent, polymer, or P—, F—, B—, S-containing chemicals. The additives function in different ways depending on the additive, such as to increase the electrochemical stability window of the electrolyte to suppress electrolyte decomposition, to induce formation of a stable surface film layer to prevent further reactions, to suppress side reactions between the electrolyte and the active materials, to suppress dendrite formations on metal surfaces and improve metal deposition, to inhibit corrosion of current collector, to facilitate wetting of electrolyte, to reduce viscosity and increase ionic conductivity of the electrolyte etc.

Some previous studies improve the cycle performance of rechargeable manganese-zinc battery by allegedly preventing the phase transform of MnO₂. For example, an ion exchange resin has been developed as separator that repels Zn²⁺, paired with a Zn²⁺-free catholyte to avoid the contact of MnO₂ cathode with Zn²⁺ from the anode side. However, such design requires a complex set-up which reduces the practical energy density of the battery. Another study demonstrates that the cycled cathode can be washed in acid to remove the covered ZnₓMn_{y}O and reassembled with new electrolyte to revive the electrode capacity. However, this approach is not practical in real-life applications. Some previous studies design nano-sized MnO₂ structures with an improved stability, however, the synthesis process is cost-intensive. In addition, these studies both directly use doped MnO₂ as the cathode material. Such pre-made doped MnO₂ may gradually be substituted by newly deposited MnO₂ without doping during the discharge/charge process and therefore cannot provide long-lasting function.

Therefore, there is a need to improve the cycling performance of rechargeable manganese-based cathode batteries. There is also a need to develop additives to improve performances of manganese-based cathode batteries.

### SUMMARY OF THE INVENTION

An embodiment of this invention relates to an electrolyte for a battery including a manganese-based cathode, the electrolyte further containing a metal/metalloid ion of the formula Mⁿ⁺ where M indicates a metal/metalloid and wherein n is from about 2 to about 4.

An embodiment of this invention relates to a battery having a manganese-based cathode, which includes the electrolyte as described herein; or wherein the electrolyte includes from about 0.05% (w/v) to about 10% (w/v); or from about 0.1% (w/v) to about 5% (w/v), metal/metalloid ion.

An embodiment of this invention relates to a method for improving performance of a battery with a Mn-based cathode, which comprises the electrolyte as described in this application.

Without intending to be limited by theory, it is believed that the present invention provides an electrolyte that can improve the cycle performance of batteries having a manganese-based cathode. It is also believed that Mn-cathode batteries including the electrolyte according to the present invention can have long-last improvement in cycle performance.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates configuration of a traditional manganese-zinc battery;

FIG. 2 illustrates the formation of irreversible ZnₓMn_{y}O phases during the charge/discharge process;

FIG. 3 illustrates the formation of M-doped MnO₂ and suppression of irreversible ZnₓMn_{y}O phases with Mⁿ⁺ as additive in the electrolyte according to the present invention;

FIG. 4A shows SEM image of the ball-milled commercial EMD nano particles that are used as active material in some embodiments herein;

FIG. 4B shows TEM image of the ball-milled commercial EMD nano particles that are used as active material in some embodiments herein;

FIG. 4C is a plot showing BET surface area of the ball-milled commercial EMD nano particles that are used as active material in some embodiments herein;

FIG. 4D is a graph showing the XRD pattern of the ball-milled commercial EMD nano particles that are used as active material in some embodiments herein;

FIG. 4E is a picture showing the crystal structure of the ball-milled commercial EMD nano particles that are used as active material in some embodiments herein;

FIG. 4F is a graph showing the SEM EDX spectrum of the ball-milled commercial EMD nano particles that are used as active material in some embodiments herein;

FIG. 5A shows a SEM image of the pristine EMD cathode;

FIG. 5B shows a SEM image of the EMD cathode discharged to 1.20 V within the 1^{st} cycle;

FIG. 5C shows a SEM image of the EMD cathode discharged to 0.80 V within the 1^{st} cycle;

FIG. 5D shows a SEM image of the EMD cathode charged to 1.52 V within the 1^{st} cycle;

FIG. 5E shows a SEM image of the EMD cathode charged to 1.80 V within the 1^{st} cycle;

FIG. 5F shows the voltage profile of the EMD cathode during the 1^{st} cycle;

FIG. 5G is a plot showing the concentration of Mn²⁺ in the electrolyte during the 1^{st} cycle;

FIG. 5H shows XRD patterns of the cathode at different discharge-charge states shown in FIG. 5F;

FIG. 5I shows XRD patterns of the EMD cathode after different cycles;

FIG. 6 is a graph showing the charge profile of an EMD-Zn cell that is disassembled after 1st discharge in 1Zn+0.1Mn electrolyte and re-assembled with 1M ZnSO₄ electrolyte without MnSO₄;

FIG. 7A is a graph showing the 1^{st} cycle voltage profiles of the cells using 1M ZnSO₄ electrolyte with and without 0.1M Mn²⁺ additive with coin cell configuration (electrolyte amount: 200 μl)

FIG. 7B is a graph showing the 1^{st} cycle voltage profiles of the cells using 1M ZnSO₄ electrolyte with and without 0.1M Mn²⁺ additive with beaker cell configuration (electrolyte amount: 5 ml);

FIG. 7C shows the coulombic efficiency comparison of the cells using 1M ZnSO₄ electrolyte with and without 0.1M Mn²⁺ additive;

FIG. 8A is a schematic illustration of the electrodeposition test configuration;

FIG. 8B is a graph showing 1^{st} cycle voltage profiles of the electrodeposition tests in 1Zn+0.4Mn and 1Zn+0.4Mn+0.5Ti electrolyte with a capacity limit of 0.5 mAh cm⁻²;

FIG. 8C is the SEM image of bare CNT electrode;

FIG. 8D is the SEM image of CNT electrode after charging in the 1Zn+0.4Mn electrolyte;

FIG. 8E is the SEM image of CNT electrode after charging in the 1Zn+0.4Mn+0.5Ti electrolyte;

FIG. 8F are the elemental mapping images of the CNT electrode after charging in the 1Zn+0.4Mn electrolyte;

FIG. 8G are the elemental mapping images of the CNT electrode after charging in the 1Zn+0.4Mn+0.5Ti electrolyte;

FIG. 9A is a graph showing the voltage profiles of the electrodeposition tests with charge capacity limit of 0.2 mAh cm⁻²;

FIG. 9B is a graph showing the voltage profiles of the electrodeposition tests with charge capacity limit of 1.0 mAh cm⁻²;

FIG. 9C is a table showing the comparison of the Coulombic efficiency in the electrodeposition tests with different capacity limits;

FIG. 10A is a graph showing cycle performances of the bare CNT//Zn electrode with electrolyte of 1Zn+0.4Mn with a fixed areal charge capacity of 0.5 mAh cm⁻² and discharge current of 0.05 mA cm⁻²;

FIG. 10B is a graph showing cycle performances of the bare CNT//Zn electrode with electrolyte of 1Zn+0.4Mn+0.5Ti with a fixed areal charge capacity of 0.5 mAh cm⁻² and discharge current of 0.05 mA cm⁻²;

FIG. 11A is a graph showing XRD patterns of the electrodes after charging from the 1Zn+0.4Mn and 1Zn+0.4Mn+0.5Ti electrolyte in the electrodeposition tests and commercial EMD;

FIG. 11B is a graph showing Raman spectra of the electrodes after charging from the 1Zn+0.4Mn and 1Zn+0.4Mn+0.5Ti electrolyte in the electrodeposition tests and commercial EMD;

FIG. 11C is a graph showing XPS Mn 2p spectra of the electrodes after charging from the 1Zn+0.4Mn and 1Zn+0.4Mn+0.5Ti electrolyte in the electrodeposition tests and commercial EMD;

FIG. 11D is a graph showing Mn 3s spectra of the electrodes after charging from the 1Zn+0.4Mn and 1Zn+0.4Mn+0.5Ti electrolyte in the electrodeposition tests and commercial EMD;

FIG. 11E is a graph showing Ti 2p spectra of the electrodes after charging from the 1Zn+0.4Mn and 1Zn+0.4Mn+0.5Ti electrolyte in the electrodeposition tests and commercial EMD;

FIG. 11F is a graph showing Zn 2p spectra of the electrodes after charging from the 1Zn+0.4Mn and 1Zn+0.4Mn+0.5Ti electrolyte in the electrodeposition tests and commercial EMD;

FIG. 11G is a graph showing DFT calculation comparison of the formation energy (ΔE) per Zn atom of Zn incorporation in EMD with and without Ti doping;

FIG. 11H shows molecular structures of EMD, Ti-doped EMD (with 3/32 Ti substitution), Zn-inserted EMD and Zn-inserted Ti-doped EMD in the DFT calculation shown in FIG. 11G;

FIG. 12A is a graph showing XPS full spectra of EMD electrodeposited in 1Zn+0.4Mn electrolyte;

FIG. 12B is a graph showing XPS full spectra of EMD electrodeposited in 1Zn+0.4Mn+0.5Ti electrolyte;

FIG. 12C is a graph showing XPS full spectra of commercial EMD;

FIG. 13A is a graph showing Raman spectra of the EMD electrodeposited in 1Zn+0.4Mn+0.5Ti electrolyte comparing with the two most common TiO2 phases (anatase TiO₂ and rutile TiO₂);

FIG. 13B is a graph showing XRD patterns of the EMD electrodeposited in 1Zn+0.4Mn+0.5Ti electrolyte comparing with the two most common TiO2 phases (anatase TiO₂ and rutile TiO₂);

FIG. 14 shows illustration of Ti doping in the EMD structure;

FIG. 15A is a graph showing CV curves of the cell using 1M ZnSO₄, 1Zn+0.1Mn, 1Zn+0.1Mn+0.5Ti electrolyte;

FIG. 15B is a graph showing rate performances of the cell using 1M ZnSO₄, 1Zn+0.1Mn, 1Zn+0.1Mn+0.5Ti electrolyte;

FIG. 15C is a graph showing cycle stability at 1200 mA g⁻¹ of the cell using 1M ZnSO₄, 1Zn+0.1Mn, 1Zn+0.1Mn+0.5Ti electrolyte;

FIG. 15D is a graph showing voltage profiles of cells with 1M ZnSO₄ electrolyte from FIG. 15C;

FIG. 15E is a graph showing voltage profiles of cells with 1Zn+0.1Mn electrolyte from FIG. 15C;

FIG. 15F is a graph showing voltage profiles of cells with 1Zn+0.1Mn+0.5Ti electrolyte from FIG. 15C;

FIG. 15G is a graph showing cycle stability of cells with different electrolytes at 3600 mA g⁻¹;

FIG. 15H is a graph showing cycle stability of cells with different electrolytes at 4800 mA g⁻¹;

FIG. 15I is a plot showing the comparison of this application with previous works regarding cycle performance;

FIG. 15J is a plot showing the comparison of this application with previous works regarding energy and power density;

FIG. 16 shows charge-discharge profiles of KB cathode without EMD at a low current of 0.3 mA;

FIG. 17 shows voltage profiles of the EMD electrode in 1Zn+0.1Mn+0.5Ti electrolyte with different current densities [1C=300 mA g⁻¹];

FIG. 18 shows cycle performance of EMD-zinc batteries using electrolyte 1M ZnSO₄+0.1M MnSO₄ with different amount of TiOSO₄ under current density 900 mA g⁻¹;

FIG. 19 A shows XRD patterns of the cycled cathode electrodes over different cycles of the cell using +0.5% (w/v) TiOSO₄ electrolyte;

FIG. 19B shows post-mortem characterizations: SEM, TEM and HRTEM images of the cathodes in the 1Zn+0.1Mn electrolyte after cycling for 500 cycles;

FIG. 19C shows post-mortem characterizations: SEM, TEM and HRTEM images of the cathodes in the 1Zn+0.1Mn+0.5Ti electrolyte after cycling for 500 cycles;

FIG. 19D is a graph showing Mn²⁺ concentration in the electrolyte of the cell with 1M ZnSO₄ along cycling;

FIG. 19E is a graph showing Mn²⁺ concentration in the electrolyte of the cell with 1Zn+0.1Mn along cycling;

FIG. 19F is a graph showing Mn²⁺ concentration in the electrolyte of the cell with 1Zn+0.1Mn+0.5Ti along cycling;

FIG. 19G is a Nyquist plot of the EIS results of the cell with 1M ZnSO₄ along cycling;

FIG. 19H is a Nyquist plot of the EIS results of the cell with 1Zn+0.1Mn along cycling;

FIG. 19I is a Nyquist plot of the EIS results of the cell with 1Zn+0.1Mn+0.5Ti along cycling;

FIG. 19J is a graph showing the equivalent circuit of the EIS results;

FIG. 19K is a plot showing Rct comparison of the cells over cycles from the EIS results.

FIG. 20 shows cycle performance of the cells using base electrolyte and +0.5% (w/v) NiSO₄ electrolyte under current density 900 mA g⁻¹;

FIG. 21 shows cycle performance of the cells using base electrolyte and +0.5% (w/v) La(NO₃)₃ electrolyte under current density 900 mA g⁻¹; and

FIG. 22 shows cycle performance of the cells using base electrolyte, +0.5% (w/v) FeSO₄ and +0.5% (w/v) Fe₂(SO₄)₃ electrolyte under current density 900 mA g⁻¹;

FIG. 23 shows cycle performance of the cells using base electrolyte, +0.5% (w/v) H₃BO₃ electrolyte under current density 900 mA g⁻¹;

FIG. 24 shows cycle performance of the cells using base electrolyte, +0.5% (w/v) MgSO₄ electrolyte under current density 900 mA g⁻¹;

FIG. 25 shows cycle performance of Mn₂O₃-zinc batteries using electrolyte 1M ZnSO₄+0.1M MnSO₄ with or without TiOSO₄ under current density 900 mA g⁻¹;

FIG. 26 shows cycle performance of δ-MnO₂-zinc batteries using electrolyte 1M ZnSO₄+0.1M MnSO₄ with or without TiOSO₄ under current density 900 mA g⁻¹; and

FIG. 27 shows cycle performance of β-MnO₂-zinc batteries using electrolyte 1M ZnSO₄+0.1M MnSO₄ with or without TiOSO₄ under current density 900 mA g⁻¹.

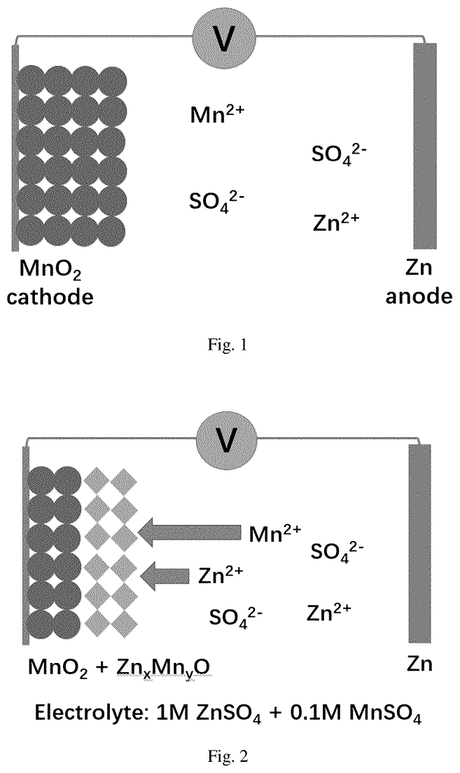

The figures herein are for illustrative purposes only and are not necessarily drawn to scale.

### DESCRIPTION OF THE PREFERRED EMBODIMENTS

Unless otherwise specifically provided, all tests herein are conducted at standard conditions which include a room and testing temperature of 25° C., sea level (1 atm.) pressure, pH 3.5-6, and all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide.

This application describes an electrolyte with additives of small amount of metal/metalloid ions for rechargeable aqueous batteries having a manganese-based cathode, to improve the cycle stability.

An embodiment of this application relates to an electrolyte for a battery including a manganese-based cathode, the electrolyte further includes a metal/metalloid ion of the formula Mⁿ⁺ where M indicates a metal/metalloid and wherein n is from about 2 to about 4.

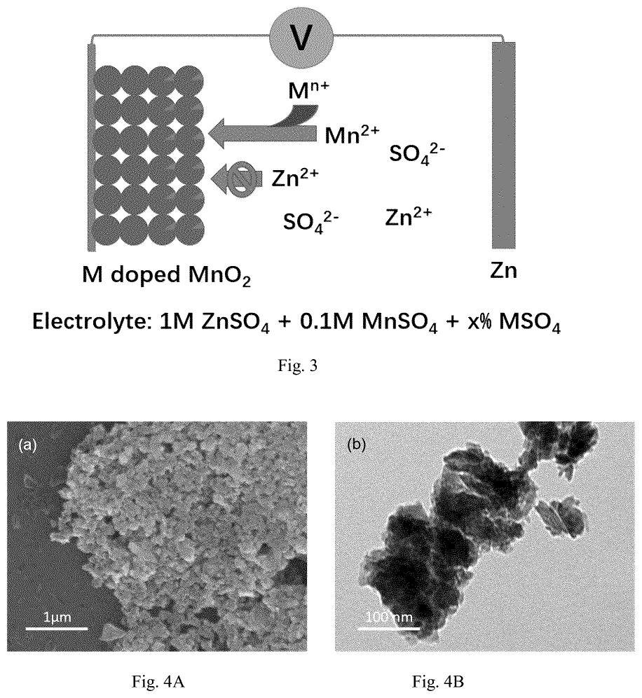

Without intending to be bound by theory, it is believed that a small amount of metal/metalloid ions included in the electrolyte can serve as in-situ doping sources to form the metal/metalloid-doped manganese-based cathode (such as doped MnO₂ cathode) during the charge/discharge process which can stabilize the cathode structure and suppress the formation of ZnₓMn_{y}O phases, as illustrated in FIG. 3. In some examples where the electrolyte includes Zinc (e.g., Zn²⁺), the electrolyte according to the present application can attain the above benefits regardless of the anode material.

In previous studies, they use pre-made doped MnO₂ as cathode, which may gradually be substituted by newly deposited MnO₂ without doping, as the MnO₂ dissolution/deposition continuously occurs during the discharge/charge process. This may result in loss of the function of suppressing the formation of ZnₓMn_{y}O phases. In comparison, it is believed that the present application solves the problem in a different way, by stabilizing the active materials with an in-situ doping of manganese-based cathode material (such as MnO₂) during charge and discharge using additives in the electrolyte. Therefore, it is believed that the in-situ doping process as described can provide a doped cathode having more long-lasting function of improving cycling performance than the pre-made doped-MnO₂. Metal/metalloid ion, for example, in its salt form, is simply added to the electrolyte to solve the technical problem. That is, we do not need to change the mass-production process of MnO₂. In addition, it is believed that in-situ doping allows more dopants on the surface of the material, which is more effective than doping of the bulk during synthesis. Furthermore, the present application can be applied to different MnO₂ polymorph structures, not only on commercial Electrolytic Manganese Dioxide (EMD).

It is also believed that, there is no publication or patent proposing similar electrolyte additives to suppress the MnO₂ phase transformation and improve the cycle performance of rechargeable manganese-zinc battery as per the present application.

In some embodiments, the metal/metalloid ion included in the electrolyte according to the present application is selected from the group consisting of Ti⁴⁺, TiO²⁺, Ni²⁺, Fe²⁺, Fe³⁺, La³⁺, Zr⁴⁺, ZrO²⁺, Sn²⁺, Bi³⁺, V⁴⁺, V³⁺, V²⁺, Al³⁺, Sb³⁺, Mg²⁺, Ca²⁺, B³⁺, and a combination thereof; or a combination thereof; or Ti⁴⁺, TiO²⁺, Ni²⁺, La³⁺, Fe²⁺, Fe³⁺, and a combination thereof. In some embodiments, the metal/metalloid ion included in the electrolyte according to the present application is selected from Ti⁴⁺, TiO²⁺, and a combination thereof. Ti⁴⁺ and TiO²⁺ may achieve the best cycle performance as shown in the examples herein. Without intending to be bound by theory, it is believed that ions of elements from the same Group, for example, Zr and Ti, Ca and Mg, Al and B, ions of elements from neighboring Groups, for example, V and Ti, would achieve similar effects in the present application.

In some embodiments, the electrolyte according to the present application includes a metal ion, and the metal ion may be a transition metal ion selected from the group of Ti ion (such as Ti⁴⁺, TiO²⁺), Ni ion (such as Ni²⁺), Fe ion (such as Fe²⁺, Fe³⁺), La ion (such as La³⁺), Zr ion (such as Zr⁴⁺, ZrO²⁺), V ion (such as V⁴⁺, V³⁺, V²⁺), and a combination thereof.

In some embodiments, the electrolyte according to the present application includes a metalloid ion selected from the group of Sb ion (such as Sb³⁺), B ion (such as B³⁺), and a combination thereof.

In some embodiments, the electrolyte according to the present application includes a metal ion, and the metal ion may be an alkaline earth metal or other metal ion selected from the group of Sn ion (Sn²⁺), Bi ion (Bi³⁺), Al ion (Al³⁺), Mg ion (Mg²⁺), Ca ion (Ca²⁺), and a combination thereof.

Normally, for manganese-zinc batteries, MnSO₄ is added to the electrolyte in order to reduce the dissolution of Mn from the MnO₂ active material into the electrolyte. The function of MnSO₄ addition is not the same as the addition of the metal/metalloid salts used in the present application, which is used to form in-situ doping of the active material. Since there are no other metal/metalloid elements in the Mn-containing active material to be dissolved into the electrolyte, it is believed that a skilled person in the art will not be able to predict that the additional of metal/metalloid salts as provided in this application, such as Ti, Ni (other than MnSO₄), would be an effective solution to improve cycle performance of Mn-based cathode batteries.

To the inventors' knowledge, there have not been any report of putting transitional metal/metalloid salt additives into the electrolyte and electrochemically dope them into the active material to improve cycle performance. In fact, the presence of transitional metal ions inside the electrolyte is detrimental to most batteries such as lithium-ion batteries as they can be transported and deposited on the anode, poisoning the anode and led to reduced battery performances. Therefore, a skilled person in the art will not expect to add transitional metal/metalloid salts into the electrolyte as they would expect the addition will degrade the battery instead.

In some embodiments, the electrolyte according to this application includes the metal/metalloid ion that is present in the form of salt. For example, the electrolyte may include any salt selected from the group of TiOSO₄, NiSO₄, La(NO₃)₃, Fe²(SO₄)₃, FeSO₄, H₃BO₃, MgSO₄, and a combination thereof. In some embodiments, the electrolyte may include TiOSO₄.

In some embodiments, the metal/metalloid ion Mⁿ⁺ is comprised in a range from about 0.1% (w/v) to about 5% (w/v) in the electrolyte according to this application. The additive amount in percentage described herein is defined as the weight of the ion's salt in 100 ml of base electrolyte. For example, 5% (w/v) TiOSO₄ means that 0.5 g of TiOSO₄ is added in 100 ml of the base electrolyte.

In some embodiments, the metal/metalloid ion Mⁿ⁺ is present in an amount of about 0.10% (w/v), about 0.2% (w/v), about 0.3% (w/v), about 0.4% (w/v), about 0.5% (w/v), about 1% (w/v), about 2% (w/v), about 3% (w/v), about 4% (w/v), about 5% (w/v), in the electrolyte according to this application. In some embodiments, the metal//metalloid ion Mⁿ⁺ is present in a range from about 0.1% (w/v) to about 0.5% (w/v), about 0.3% (w/v) to about 1% (w/v), about 0.4% (w/v) to about 2% (w/v), or about 3% (w/v) to about 4% (w/v), or about 3% (w/v) to about 5% (w/v), in the electrolyte according to this application.

In some embodiments, the metal/metalloid ion is served as an in-situ doping source to form a metal/metalloid-doped manganese-based cathode during a charge/discharge process of the battery. Without intending to be bound by theory, it is believed that the metal/metalloid ions used herein can enter the manganese cathode material during the charge/discharge process and suppress the incorporation of Zn ions.

An embodiment of this application relates to a battery with a Mn-based cathode, comprising the electrolyte as described above; or wherein the electrolyte includes from about 0.05% (w/v) to about 10% (w/v); or from about 0.1% (w/v) to about 5% (w/v), metal/metalloid ion.

In some embodiments, the manganese-based cathode includes a cathode material selected from the group of MnO₂, MnO, Mn₃O₄, Mn₂O₃, MnOOH, and a combination thereof. Without intending to be bound by theory, it is believed that the inactive ZnₓMn_{y}O phases may be formed because of the reaction between Zn and Mn oxides. Also, it is believed that Mn oxides as cathode will eventually transfer into MnO₂ during the charge/discharge process in this system so the reaction thereafter will be the same. During the charge/discharge process of the battery, the metal/metalloid ion additives in the electrolyte will enter into the cathode material and thereby forming doped MnO₂ and preventing the formation of inactive ZnₓMn_{y}O phases on the cathode. In some embodiment, MnO₂ is attractive because it is environmentally friendly, available in large quantity and also has high capacity.

In some embodiments, in the battery according to this application, the cathode material is MnO₂. MnO₂ are produced in large commercial scale, and thus are easily available.

In some embodiments, in the battery according to this application, the cathode material MnO₂ has different polymorphs selected from the group consisting of α, β, γ, δ, λ, Ramsdellite and Electrolytic Manganese Dioxide (EMD) structures. In some embodiments, the cathode material MnO₂ has EMD structure. Without intending to be bound by theory, it is believed that EMD structure has a disordered structure which allows higher capacity and easier reaction between the cathode and the metal/metalloid ion for doping.

In some embodiments, in the battery according to this application, the manganese-based cathode comprises a Mⁿ⁺ doped structure in the cathode after charge/discharge cycles, which prevents the manganese-based cathode from transforming into electrochemically inert phases.

In some embodiments, the battery according to this application may include an anode. The anode includes a material selected from the group of Zinc, Zinc alloys such as brass, and a combination thereof. In some embodiments, the battery according to this application may be an anode-less battery, where Zinc is deposited on, for example, Cu or carbon.

In some embodiments, the battery is an aqueous zinc-ion battery. It is believed that aqueous rechargeable Zn-ion batteries (ARZIBs) are promising for grid-scale energy storage applications owing to the merits in abundant Zn source, intrinsic safety, and low cost.

In some embodiments, the battery is an aqueous zinc-ion battery using manganese-based material as cathode, for example, the battery may comprise a MnO₂—Zn system. It is believed that the electrolyte additive according to this application can improve the stability of MnO₂, and thereby preventing capacity fading upon cycling and improving the electrochemical performance of aqueous MnO₂—Zn batteries.

In this application, we develop novel and facile electrolyte additives to suppress the phase transformation usually happens in traditional rechargeable manganese-zinc batteries, and also stabilize the cathode structure. Specifically, we develop different metal/metalloid ions as electrolyte additives, which can enter the manganese cathode material during the charge/discharge process and suppress the incorporation of Zn ions. Therefore, the cycle performance can be dramatically improved.

An embodiment of this application relates to a method for improving performance of a battery with a Mn-based cathode, which comprises the electrolyte as described above.

The electrolyte and the battery as described above apply to this embodiment.

As described herein, when the battery is charged and discharged, the electrolyte additive comprising the metal/metalloid ion herein may form a metal/metalloid-doped manganese-based cathode via in-situ doping. Without intending to be bound by theory, it is believed that the addition of metal/metalloid salts (such as TiOSO₄) as a facile electrolyte additive suppresses the emergence of the inactive phase by forming a Ti-doped MnO₂ during cycling, thereby improving the cycling stability of the electrode.

Inactive phase formation upon cycling was reported as one of the causes of the poor electrochemical reversibility for different MnO₂-based polymorphs. So far, many strategies such as surface coatings, designing different MnO₂ morphologies and crystal structures, introducing vacancies and dopants, and electrode additive etc. are proposed to overcome the issue. However, most of the reported works are only able to demonstrate stable cycling performances under high current rate with low capacity utilization (e.g. <150 mAh g⁻¹ over 1000 cycles), as the presence of the MnO₂—Mn²⁺ dissolution-deposition reaction during each cycle would inevitably negate the effect of the originally designed MnO₂ structure.—For practical applications, it is desirable to find an alternative method to suppress the formation of inactive phases to maintain a high capacity utilization of over 200 mAh g⁻¹ for extended number of cycles.

In this application, we first systematically study the charge storage mechanism and inactive phase formation process of electrolytic manganese dioxide (EMD). Specifically, proton (de)insertion and MnO₂ dissolution-deposition reactions are observed to occur simultaneously to contribute to the capacity. At the same time, inactive ZnMn₂O₄ and ZnMn₃O₇ phases gradually emerge in the electrode upon cycling. These new Zn-containing phases are formed during a co-deposition of Mn²⁺ and Zn²⁺ during charging, as verified by an electrodeposition test of EMD onto a cathode-free carbon nano-tube (CNT) electrode.

The present application further demonstrates that the addition of TiOSO₄ as an electrolyte additive is an effective method to suppress the formation of the Zn-containing phases via the in-situ formation of a Ti-doped EMD during cycling, significantly improving the cyclability of MnO₂. Experimental data indicate that the Ti-doped EMD is favourably formed compared to Zn—Mn—O phases, and the stability is confirmed by density functional theory (DFT) calculations. With 0.5% (w/v) TiOSO₄ additive, MnO₂—Zn battery demonstrates a stable capacity of about 230 mAh g⁻¹ for over about 1500 cycles under a current of about 1200 mA g⁻¹, corresponding to a charge-discharge time of about 12 mins (5C rate). Stable cycling can be achieved at even higher current rates, with a capacity of about 113 mAh g⁻¹ at about 3600 mA g⁻¹ (about 15 C) after about 6000 cycles and about 92 mAh g⁻¹ at about 4800 mA g⁻¹ (about 30 C) after about 10000 cycles. The superior cyclability of MnO₂ is due to the improved stability of EMD with TiOSO₄ additive, as confirmed by X-ray diffraction (XRD) results after cycling. In addition, inductively-coupled plasma (ICP) spectroscopy results show that the changes in Mn²⁺ concentration in the electrolyte are reversible while electrochemical impedance spectroscopy (EIS) measurements reveal that cell resistance of MnO₂—Zn batteries is stable over cycling with TiOSO₄ additive.

### EXAMPLES

### Methods and Tests

Unless specified otherwise, the following materials and conditions are used to carry out the examples.

### 1. Electrolyte Preparation

ZnSO₄·H₂O (>99.9%), MnSO₄·H₂O (>99%) and titanium oxysulfate TiOSO₄ (>29% Ti basis) are purchased from Sigma Aldrich.

The ZnSO₄+MnSO₄ electrolyte (base electrolyte) is prepared through dissolving 1M ZnSO₄ and 0.1M MnSO₄ in de-ionized water (denoted as “1Zn+0.1Mn”).

Similarly, the “1Zn+0.4Mn” electrolyte is prepared by dissolving 1M ZnSO₄ and 0.4M MnSO₄.

The “1Zn+0.1Mn+0.5Ti” and “1Zn+0.4Mn+0.5Ti” electrolytes are prepared through dissolving 0.5% (w/v) TiOSO₄ in the ZnSO₄+MnSO₄ electrolytes. Electrolytes with other TiOSO₄ contents are prepared with the same method.

All the electrolytes are prepared by stirring the electrolyte salts in de-ionized water for more than one hour at room temperature.

### 2. Cell Assembly

For making the electrolytic manganese dioxide (EMD) electrode, commercial EMD (Xiangtan Electrochemical Scientific Ltd.) is first ball-milled in zirconium oxide bowls at 200 rpm for 12 hours with ethanol as the dispersant (EMD ethanol=1:1 in mass) to reduce the particle size. The resultant powder is dried at 60° C. for 4 hours under vacuum to evaporate the ethanol.

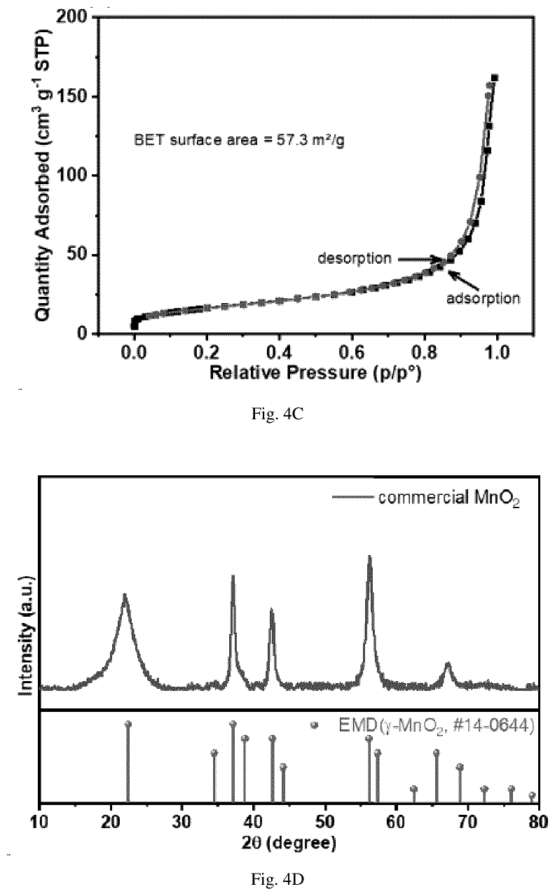

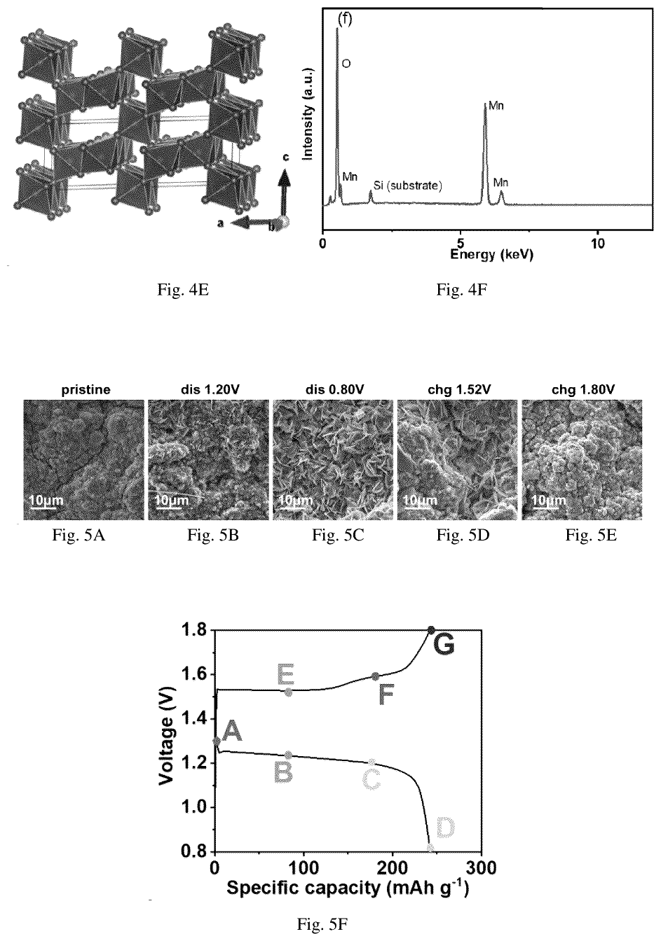

The ball-milled material has a particle size of ˜100 nm from SEM and TEM observations (FIGS. 4A and 4B). BET surface area of the material is 57.3 m² g⁻¹ (FIG. 4C). The crystal structure of EMD is 7-MnO₂ as shown from XRD data (FIGS. 4D and 4E). EDX analysis of the material shows that it contains Mn and 0.

The ball-milled EMD is well mixed with Ketjen Black (KB, ECP-600JD, Lion Corporation, Japan) and polyvinylidene fluoride (PVdF, solef 5130, Solvay, France) in N-methyl-2-pyrrolidone (NMP) with a ratio of 7:2:1 to make a homogeneous slurry, which is coated on graphite paper (GP, 50 m thick, Chenxin Induction Equipment, China). The electrodes are punched out into a disc with a diameter of 16 mm and dried at 80° C. for 4 hours. The typical EMD mass loading is ˜1.5 mg cm⁻². Coin cells are assembled using the as-described electrode as cathode, zinc foil (Sigma Aldrich, 99.9%, 0.05 mm thick) as anode, and glass fiber (Advantec #GD-120, Toyo Roshi Kaisha Ltd., Tokyo, Japan) as separator with 200 μl electrolyte. For other electrode materials, for example, those used in Example 6 (Mn₂O₃, δ-MnO₂, β-MnO₂), the batteries are assembled in the same way unless otherwise specified.

For the electrodeposition tests, a carbon nano-tube (CNT) sheet is used as the cathode. To prepare the cathode substrate, single-wall carbon nanotube dispersion (SWCNT, 13% (w/v) in water, Jiacai Technology Co., Ltd., Shanghai, China) is diluted 20 times with de-ionized water and stirred for 2 hours at 70° C. Then, the solution is filtered through a hydrophilic PTFE membrane by vacuum filtration to generate the free-standing CNT electrode with a thickness of about 10 m. The CNT electrode is then coupled with Zn anode and made into a coin cell, similar to the MnO₂—Zn batteries.

### 3. Electrochemical Tests

Galvanostatic charge-discharge tests are performed using a Neware battery tester (Neware, Shenzhen, China) between 0.8 V and 1.8 V. Cyclic voltammetry (CV, scanning rate 0.1 mV s⁻¹) and electrochemical impedance spectroscopy (EIS, frequency range 1 MHz to 0.01 Hz) measurements are performed on a potentiostat (Bio-logic VMP3, France).

For the electrodeposition tests, the cell is first charged with a constant current of 0.05 mA cm⁻² to 1.8 V followed by a constant voltage step until the areal capacity reached 0.5 mAh cm⁻², and then discharged to 0.8 V with 0.05 mA cm⁻².

### 4. Characterizations

The morphological evolutions of the electrodes are characterized by scanning electron microscopy (SEM, QUATTROS), energy dispersive X-ray (EDX) spectroscopy, and transmission electron microscopy (TEM, JEOL 2100 F). X-ray photoelectron spectroscopy (XPS, Thermo Scientific Escalab), X-ray diffraction (XRD, Panalytical X'Pert3 X-ray Diffractometer, Cu Kα radiation source, λ=1.5418 Å) and Raman spectroscopy (WITec RAMAN alpha 300R @R7167 BOC) are used to study the crystal structure changes of the electrodes. Nitrogen adsorption tests at 77 K using Micromeritics 3Flex is applied to obtain the Brunauer-Emmett-Teller (BET) surface area. Inductively-coupled plasma atomic emission spectroscopy (ICP-AES, PE optima 6000) is used to detect the Mn²⁺ ion concentrations in the electrolytes, and each data point is measured three times. To prepare the electrolyte samples for inductively-coupled plasma (ICP), all parts from a disassembled coin cell are soaked in 20 ml de-ionized water and stirred overnight before sampling.

### 5. Density Functional Theory Calculations

Density Functional Theory (DFT) calculations are performed using the Quantum Espresso package. The ultrasoft GBRV pseudopotentials are used with the PBE exchange correlation functionals. The wavefunction and augmented charge density cutoffs are set to 40 Ry and 280 Ry, respectively. PBE+U corrections are introduced to the Mn atoms with a U value of 4 eV. F-point sampling is used for both the MnO₂ and ZnMn₂O₄ systems with lattice parameters obtained from the XRD tests mentioned earlier. For the case of MnO₂, the lattice parameters obtained from XRD matches the Ramsdellite phase. As a result, a Mn₃₂O₆₄ orthorhombic simulation cell with lattice parameters of 8.18 Å×10.15 Å×12.72 Å is used. For the ZnMn₂O₄ system, a Zn₁₆Mn₃₂O₆₄ tetragonal simulation cell with lattice parameters of 11.44 Å×11.44 Å×9.25 Å is used. Starting from the pristine MnO₂ and ZnMn₂O₄ systems, the Ti-doped MnO₂ and ZnMn₂O₄ systems are generated by successively replacing randomly chosen Mn atoms with Ti atoms. Finally, a 2×2×2 hexagonal supercell with lattice parameters of 5.33 Å×5.33 Å×9.89 Å and 8×8×8 k-point sampling is used for the Zn metal system with 16 Zn atoms per simulation cell.

### Mechanism of Zn—Mn Oxides Formations

Commercial EMD is selected as the active material in this example for investigation of the MnO₂—Zn battery. The EMD electrode is prepared by using the method described above. Paired with a 1Zn+0.1Mn electrolyte, the galvanostatic test is performed from 0.8 V to 1.8 V under a current density of 1200 mA g⁻¹, starting with a discharge process. To investigate the phase and cathode morphology changes during cycling, ex-situ SEM, XRD and ICP are conducted.

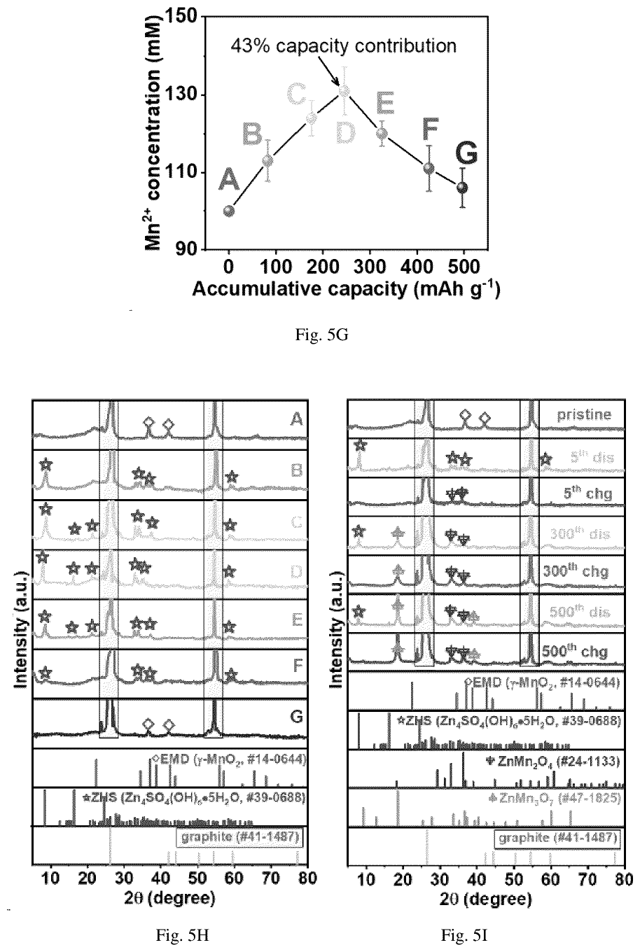

SEM images of the EMD cathode under different voltages within the 1^{st} cycle are shown in FIGS. 5A to 5E. In FIG. 5A, at open circuit voltage, the cathode is mainly composed of compact EMD particles. When the battery is discharged to 1.2 V, flake-like products gradually emerge on the electrode surface (FIG. 5B). After the cell is fully discharged to 0.8 V, the electrode surface is completely covered by the flakes (FIG. 5C). Along with the charge process, the flakes gradually disappear, and the original particle-like morphology is observed again (FIGS. 5D and 5E).

XRD patterns of the cathode under different states in the first cycle (FIG. 5F) are shown in FIG. 5H. The zinc sulfate hydroxide (ZHS, Zn₄SO₄(OH)₆·4H₂O, JPCDS #44-0673) peaks are found to grow during discharge process and disappear during charge process, especially the main peak located at 8.5°. This is consistent with the observation of the flakes in the SEM results.

The ZHS precipitation and dissolution is known to be caused by the increase and decrease of the pH of the electrolyte, respectively, indicating the occurrence of proton-coupled reactions (PCRs) during the discharge-charge process. The PCRs in the MnO₂—Zn system are still under debate, while there are two generally recognized pathways:

1) H⁺(de)insertion reaction: MnO₂+H⁺+e⁻⇔HMnO₂ (1)

Or MnO₂+H⁺+e⁻⇔MnOOH (2)

2) Mn dissolution/deposition reaction: MnO₂+4H⁺+2e⁻⇔Mⁿ²⁺+2H₂O (3)

Meanwhile, the initial XRD peaks of EMD located at 37.0° and 42.6° are weakened during the first discharge from state B to state D with the emergence of the ZHS phase. During charge, the ZHS peaks gradually disappear while the peaks of EMD re-emerge until the fully charged state G. Though the possibilities of both pathways cannot be excluded, as the weakened EMD peaks at the discharged state can be caused by either the disordered H⁺-inserted EMD phase or the partial dissolution of the EMD.

A direct method to distinguish the two processes and quantify the contribution from the Mn dissolution/deposition reaction is to measure the Mn²⁺ concentration in the electrolyte. The ICP results of the Mn²⁺ concentration during the first cycle is shown in FIG. 5G. Since the electrolyte contains 0.1 M MnSO₄, the initial Mn²⁺ concentration is 100 mM. During initial discharge, the Mn²⁺ concentration increases linearly by around 30 mM, which suggests that Mn dissolution accounts for a capacity of 107.2 mAh g⁻¹ (42.8% of the observed capacity) based on Eq (2) (see Calculation Method below). The other 57.2% of the capacity is likely to be from proton insertion (Eq. (1)).

### Calculation Method:

The average mass loading of EMD is 1.5 mg cm⁻², and the electrode disc with 16 mm diameter has an area of 2 cm⁻². Since the molecular weight of MnO₂ is 87 g mol-1, the total number of moles of Mn in the cathode is:

$$1.5 mg {cm}^{- 2} \times 2 {cm}^{2} \div 87 g {mol}^{- 1} = 0.0345 mmol$$

The increased amount of dissolved Mn²⁺ in the 0.2 ml electrolyte after 1^{st} discharge is:

$$30 mM \times 0.2 ml = 0.006 mmol$$

The percentage of Mn dissolved from the EMD active material after 1^{st} discharge=0.006/0.0345=17.4%.
Since Mn dissolution is a 2e⁻ transfer reaction with a total capacity of 616 mAh g⁻¹, therefore, the contributed capacity from Mn dissolution is

$$616 mAh {g}^{- 1} \times 17.4 \% = 107.2 mAh {g}^{- 1}$$

As the total 1^{st} discharge capacity is 250 mAh g⁻¹, about 107.2 mAh g⁻¹ 250 mAh g⁻¹ 42.8% of the initial discharge capacity is contributed by Mn dissolution.

When the MnO₂ electrode is charged, the Mn²⁺ content decreases, indicating that it is re-deposited onto the electrode. After end of 1^{st} charge (state G with a charge capacity of 244 mAh g⁻¹), the Mn²⁺ concentration drops back close to the initial value of 100 mM.

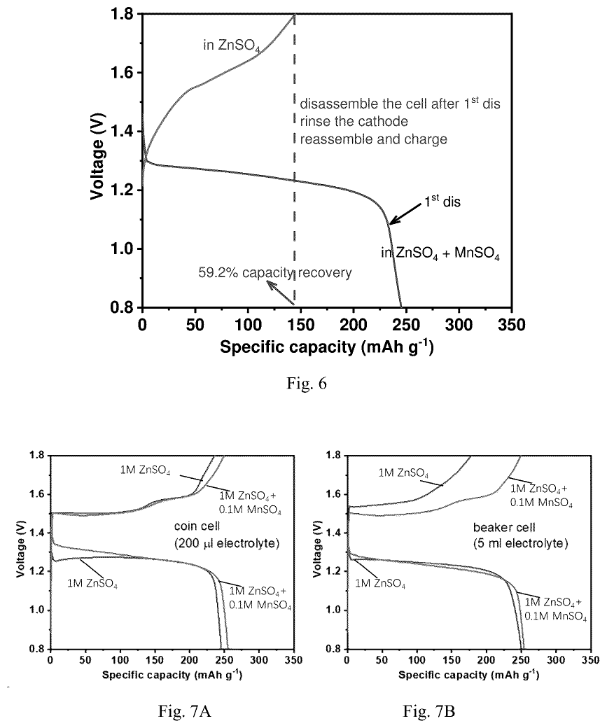

The contribution to the initial charge capacity from Mn re-deposition is further analyzed with the following electrolyte-swapping experiment—an EMD electrode is initially discharged to 0.8 V in 1Zn+0.1Mn electrolyte. The cell is then disassembled and the EMD electrode is washed carefully with de-ionized water to remove the electrolyte. The electrode is then re-assembled into a battery with ZnSO₄ electrolyte without MnSO₄ and charged. The charge profile of the cell with electrolyte-swapping is shown in FIG. 6, which is different from the usual charge curve in FIG. 5F. Specifically, while the usual MnO₂—Zn battery without electrolyte swapping shows a first Coulombic efficiency of about 100% (FIG. 5F), the electrolyte-swapped cell without dissolved Mn²⁺ only shows a charge capacity of 145 mAh g⁻¹, corresponding to 59.2% of the discharge capacity, as there is no MnO₂ re-deposition. The obtained capacity is consistent with that from proton removal as calculated above, which also confirms that the re-deposition of the dissolved Mn²⁺ is an essential process that contributes to the charge capacity.

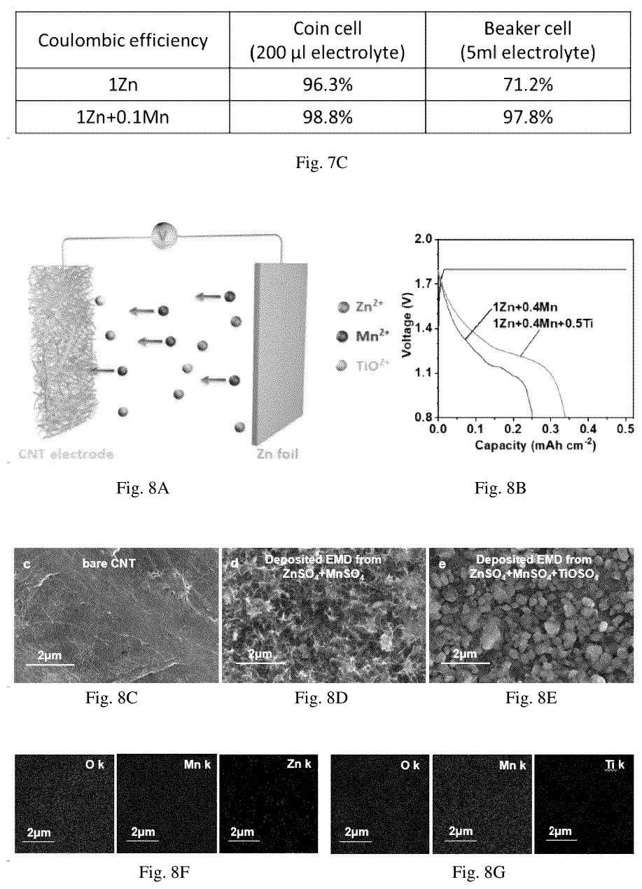

It is noteworthy that even though there is 0.1M MnSO₄ pre-added into the electrolyte, there is still a considerable amount of Mn dissolution that gives rise to the reversible capacity. This observation is contradictory to a common belief that the Mn²⁺ additive can suppress the Mn dissolution caused by Jahn-Teller effect. In fact, considering the MnO₂—Zn system as a partial electrolytic Mn—Zn battery, the Mn²⁺ additive in the electrolyte can act as a Mn reservoir to promote the re-deposition of Mn²⁺, thereby improving the reversibility of the MnO₂ dissolution/deposition reaction. The effect is more obvious in the case of excess electrolyte. FIGS. 7A to 7C show the 1^{st} cycle charge-discharge profile of MnO₂—Zn batteries in 1M ZnSO₄ electrolyte with or without MnSO₄ additive in an electrolyte-lean coin cell (200 μL) and an electrolyte-rich beaker cell (5 ml). For both cells with 1Zn+0.1Mn electrolyte, they show similar voltage profiles, capacity and first cycle efficiency as there is ample Mn²⁺ in the electrolyte that can be re-deposited during charging. On the other hand, the cells tested in 1M ZnSO₄ exhibit a much lower rechargeable capacity in a beaker cell with excess electrolyte comparing to a coin cell configuration. This is because the dissolved Mn²⁺ ions during the discharge process are diffused away from the electrode surface into the bulk electrolyte and it is more difficult for them to be re-deposition if there is larger amount of electrolyte.

While the addition of Mn²⁺ in the electrolyte improves the cyclability of MnO₂ electrode by facilitating Mn dissolution/deposition, capacity fading is still observed during long-term cycling due to the formation of inactive Zn—Mn—O phases. As shown in FIG. 5I, after 5 cycles, weak ZnMn₂O₄ XRD peaks located at 32.9° and 36.4° (JPCDS #24-1133) replace the original EMD peaks. After 300 cycles, the characteristic XRD peak of ZnMn₃O₇ (JPCDS #47-1825) shows up at 18.5°. We can find that these Zn-containing phases exist under both the discharge and charge states after 300 cycles, and their X-ray peak intensities grow along with cycle number, which indicates their irreversibility and accumulation. Meanwhile, the peak intensity of the ZHS is weakened with cycling, which is consistent with the reduced reversible capacity from the PCRs, which will be further discussed in a later section. These Zn-containing phases can form due to the co-deposition of Zn²⁺ and Mn²⁺ during the charge process according to the following equation:

xZn²⁺+yMn²⁺+H₂O→ZnₓMn_{y}O+2H⁺+(2-2ₓ-2_{y})e⁻ (4)

Because these phases are known to be electrochemical inactive with low electrical conductivity, it is believed that their formation will consume the active Mn and impede ion transfer in the electrode. This degradation process will be expedited in MnO₂ electrode that shows large capacity with more contribution from Mn dissolution/deposition, while it may be insignificant when the capacity is lower at higher current rate. This may explain why some previous works on MnO₂—Zn batteries are able to demonstrate high stability with a relatively low capacity utilization, as there would be less inactive phase formation each cycle. To maintain MnO₂ electrode with a high capacity for practical applications, the present application surprisingly provides a method to suppress the formation of the inactive Zn—Mn—O phases with cycling.

### In-Situ Doping

To solve the above-mentioned technical problem in prior art, the inventors introduce salts of metal/metalloid ions, such as TiOSO₄, as a dopant source in the electrolyte to form Ti-doped EMD through the co-deposition of Mn²⁺ and TiO²⁺ during the charging process. It is found that after adding TiOSO₄ into the electrolyte, the cycle stability of EMD electrode is significantly improved (as discussed in a later section), and the formation of Zn-containing phases upon cycle is suppressed.

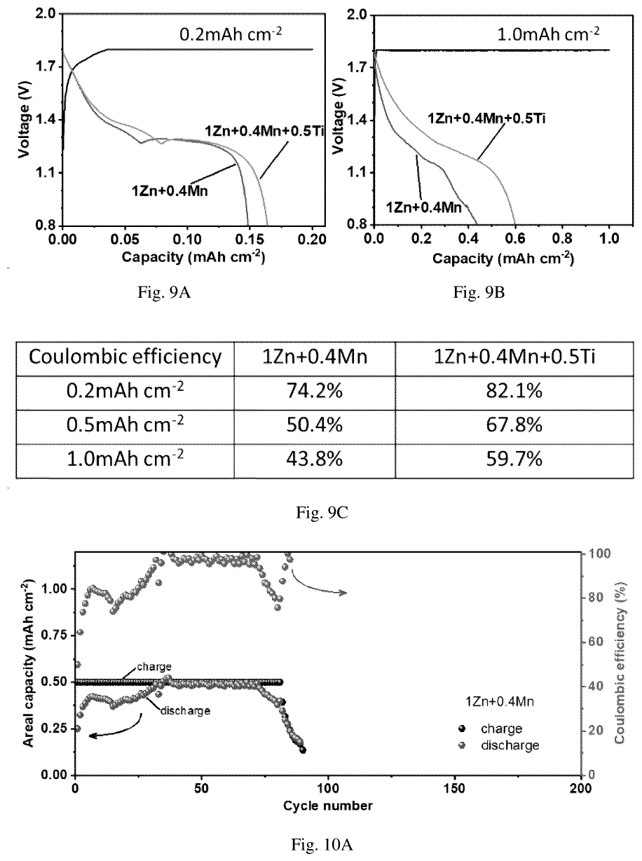

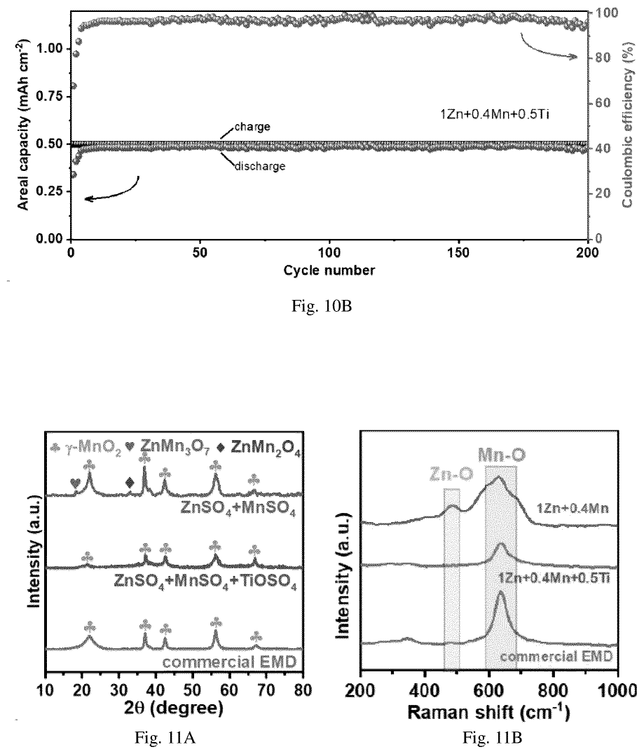

To clarify the effect of TiOSO₄ additive, we design an electrodeposition test as illustrated in FIG. 8A that only undergoes Mn deposition/dissolution process. A bare CNT film is used as the cathode, paired with the 1Zn+0.4Mn with and without 0.5% TiOSO₄ additive as the electrolyte. Note that the MnSO₄ content in the electrolyte is higher in the electrodeposition test compared to the battery test so as to facilitate Mn deposition. Through charging at a constant voltage of 1.8 V, Mn²⁺ in the electrolyte is oxidized to EMD and deposited on the CNT substrate surface. The cells are charged to a capacity limit of 0.5 mAh cm⁻² (corresponding to the deposition of 0.81 mg cm⁻² of MnO₂ assuming 2e⁻ transfer) and then discharged. From the voltage profiles shown in FIG. 8B, one can see that the cell tested in 1Zn+0.4Mn+0.5Ti electrolyte exhibits a larger initial discharge capacity, as compared to that with the 1Zn+0.4Mn electrolyte. Similar behaviors are also observed with different areal capacity limits (FIGS. 9A to 9C). This indicates that the EMD deposited with TiOSO₄ additive is more reversible. Apart from the higher 1^{st} cycle reversibility, EMD deposited in 1Zn+0.4Mn+0.5Ti electrolyte also shows improved cyclability (FIGS. 10A and 10B).

SEM and EDX are used to investigate the morphology and composition of the deposited EMDs after charging. While the pristine CNT electrode shows a smooth surface (FIG. 8C), the deposited EMD in the 1Zn+0.4Mn electrolyte exhibits a flake-like structure (FIG. 8D), while the one with TiOSO₄ is particle-like (FIG. 8E). EDX images (FIG. 8F) show that the different elements are distributed uniformly in the deposited samples, with a small amount of Zn in EMD deposited without TiOSO₄ and Ti in the one deposited with TiOSO₄. The specific atomic ratios are listed in Table S1.

TABLE S1
Atomic percentage of each element in the deposited
EMD after charging in different electrolytes.

| | Atomic % (deposited in | Atomic % (deposited in |
|---|---|---|
| Element | 1Zn + 0.4Mn electrolyte) | 1Zn + 0.4Mn + 0.5Ti electrolyte) |
| O | 73 | 65 |
| Mn | 22 | 32 |
| Zu | 5 | <1 |
| Ti | <1 | 3 |
| S | <1 | <1 |

For both samples, Mn and O are the main elements, as the deposited product is mainly MnO₂. Meanwhile, no S element is observed in both samples, inferring that S is not incorporated into the materials, and that the electrolyte is thoroughly removed during washing. Hence, the observed Zn element in the EMD deposited without TiOSO₄ is not due to residual electrolyte, but the co-deposition of Zn and Mn during the charge process. In comparison, the material deposited in 1Zn+0.4Mn+0.5Ti electrolyte shows insignificant amount of Zn element with about 3% of Ti. This suggests that Ti is preferably doped into the EMD instead of Zn.

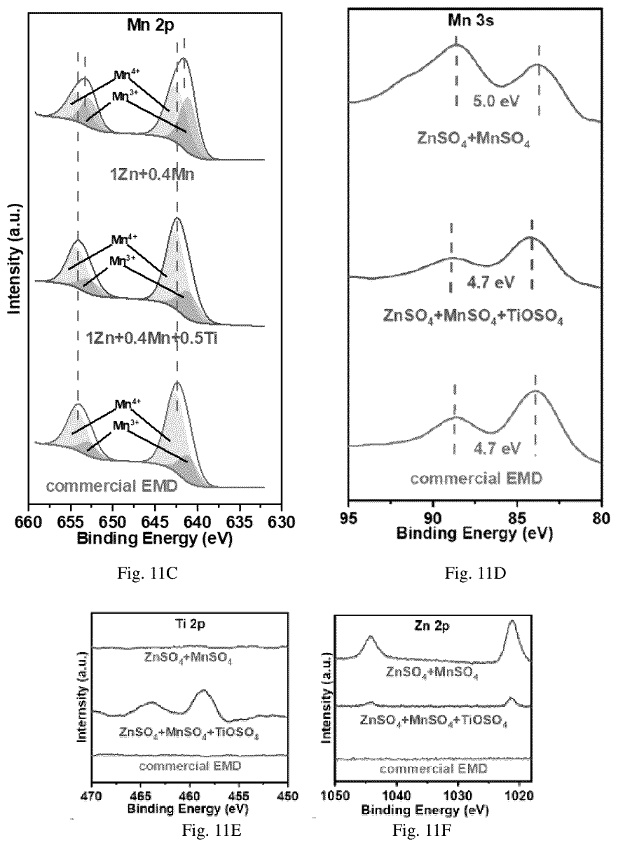

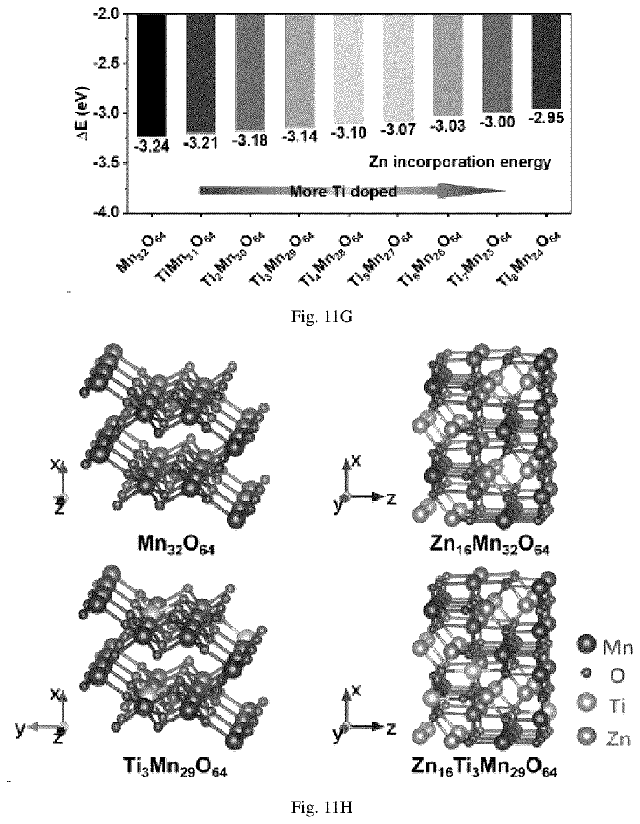

For a more comprehensive analysis of the above electrodes, other characterizations are applied. XRD patterns in FIG. 11A confirm that both deposited products to be mainly EMD, with similar peaks as the commercial EMD. For the sample deposited in 1Zn+0.4Mn, small peaks corresponding to ZnMn₂O₄ and ZnMn₃O₇ can be observed, which indicate that there is Zn-containing side-products from the EMD deposition, apart from the main reaction. The formation of these inactive phases can explain why the capacity of MnO₂—Zn battery gradually decreases with cycling. On the other hand, the peaks of the EMD deposited in 1Zn+0.4Mn+0.5Ti electrolyte are broader, which is attributed to the reduced crystallinity of the EMD with Ti doping.

Raman spectra of the 2 electrodes are compared in FIG. 11B. The EMD deposited in the TiOSO₄-containing electrolyte exhibits only the Mn—O peak located at 636 cm⁻¹ similar to that of commercial EMD, while the electrode deposited in 1Zn+0.4Mn electrolyte contains an extra peak at 486 cm⁻¹, which can be attributed to the Zn—O peak in ZnₓMn_{y}O phases.

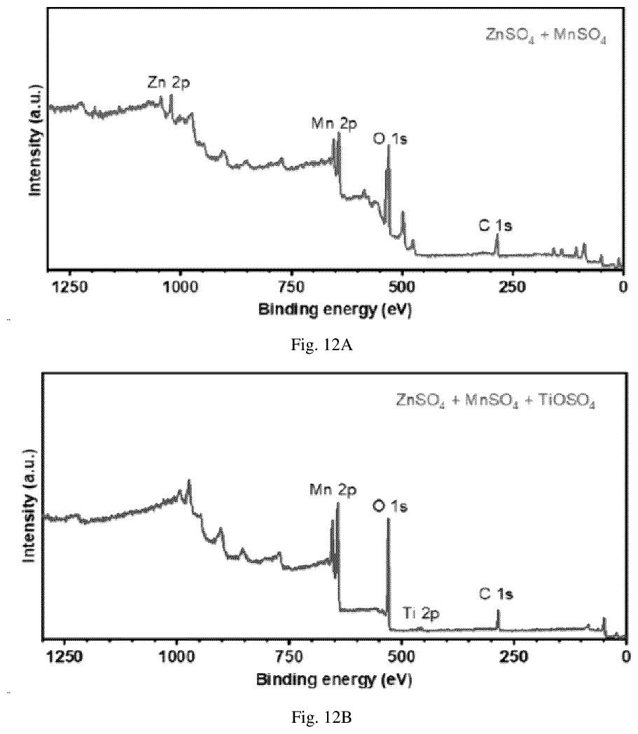

The samples are also analyzed with XPS to further investigate the Mn valence states. The Mn 2p spectra can be deconvoluted into Mn⁴⁺ and Mn³⁺ doublet peaks as shown in FIG. 11C. Comparing to the commercial EMD and the electrode deposited with TiOSO₄, the Mn 2p peaks of the electrode deposited in 1Zn+0.4Mn shift to a lower binding energy, suggesting that the contribution of Mn³⁺ peaks is higher. Moreover, the magnitude of Mn 3s peak splitting of the electrode in 1Zn+0.4Mn also increases compared to the other two samples (FIG. 11d). As the magnitude of Mn 3s peak splitting depends on the Mn oxidation state because of the coupling of non-ionized 3s electron with 3d valence-band electrons, both Mn 2p and 3s spectra reveal that the Mn average oxidation state of the deposited EMD without Ti is lower. This is consistent with the presence of ZnMn₂O₄ products as shown in the XRD analysis with a Mn valance of 3+. The co-deposition of Zn with Mn is also verified as Zn 2p XPS peaks can be observed from the electrode (FIG. 11F and FIGS. 12A-12C).

On the other hand, the deposited EMD from the TiOSO₄-contained electrolyte shows mainly XPS peaks corresponding to Mn⁴⁺, which indicates that Ti not only suppresses the formation of Zn-containing products but also has little effect on Mn valence of the product. A small amount of Ti is incorporated into the deposited EMD, as Ti 2p XPS peaks can be observed in the electrode made with TiOSO₄ (FIG. 11E and FIGS. 12A-12C), consistent with the EDX results (Table S1).

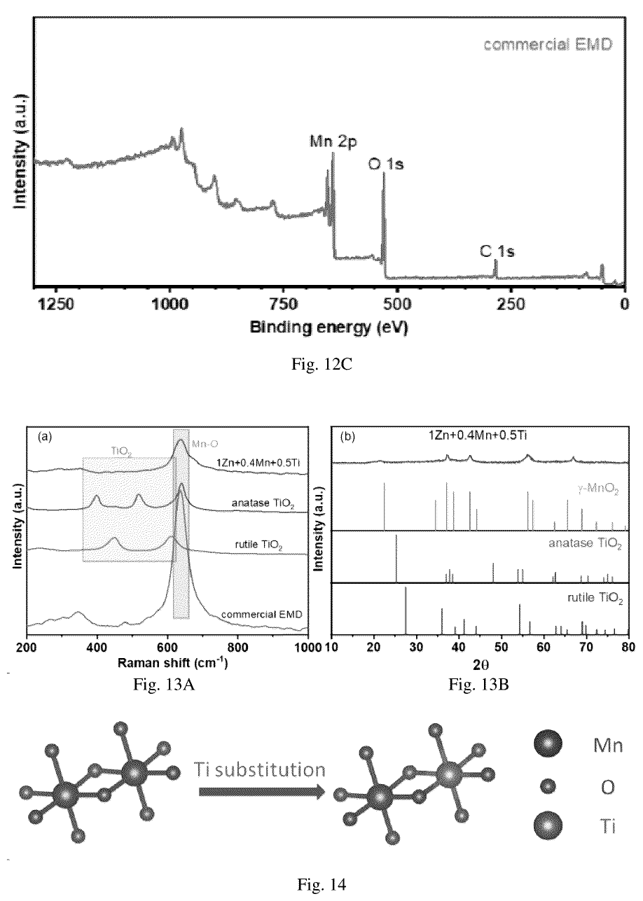

Even though we found Ti element in the deposited EMD electrode, there are three possible forms for its presence: TiO₂, Ti species within the EMD tunnels, or dopant in the EMD framework. First, TiO₂ is not detected from the Raman spectrum and XRD pattern (FIGS. 13A and 13B) of the electrode. Second, the tunnels of EMD with a size of 2.3 Å×2.3 Å and 2.3 Å×4.6 Å are most likely not large enough to accommodate Ti species since the total lengths of Ti—O bonds are around 3.7 Å. It is therefore likely that Ti⁴⁺ is incorporated into the MnO₆ octahedral units of EMD, as Mn and Ti have similar size, charge, and coordination number, as illustrated in FIG. 14.

To understand the reason why Ti-doped EMD can suppress the formation of Zn-containing phases, first-principles DFT calculations are further performed. First, we calculate the formation energy (ΔE) of EMD (MnO₂) and compare with that of ZnMn₂O₄. We found that ZnMn₂O₄ has a lower ΔE of 3.24 eV per Zn atom than MnO₂, indicating that it is more energetically favorable for Zn to be incorporated into the structure (FIG. 11G). We then gradually replace the Mn atom in the framework with Ti (TiₓMn₃₂₋ₓO₆₄) (FIG. 11H) and calculated the energy needed to incorporate Zn into it. Our result shows that the formation energy of Zn-containing compound increases with Ti substitution, which suggests that Ti-doping in the EMD structure suppresses the incorporation of Zn into the structure, consistent with the experimental results.

### Example 1

### Electrochemical Performances

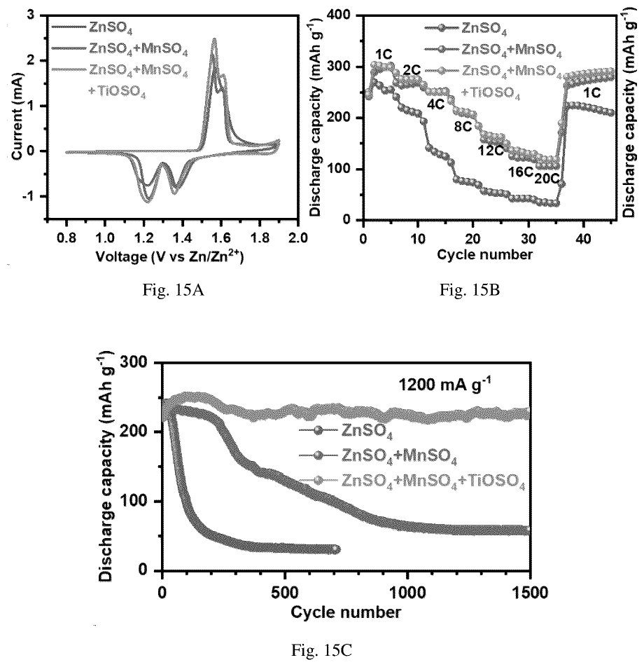

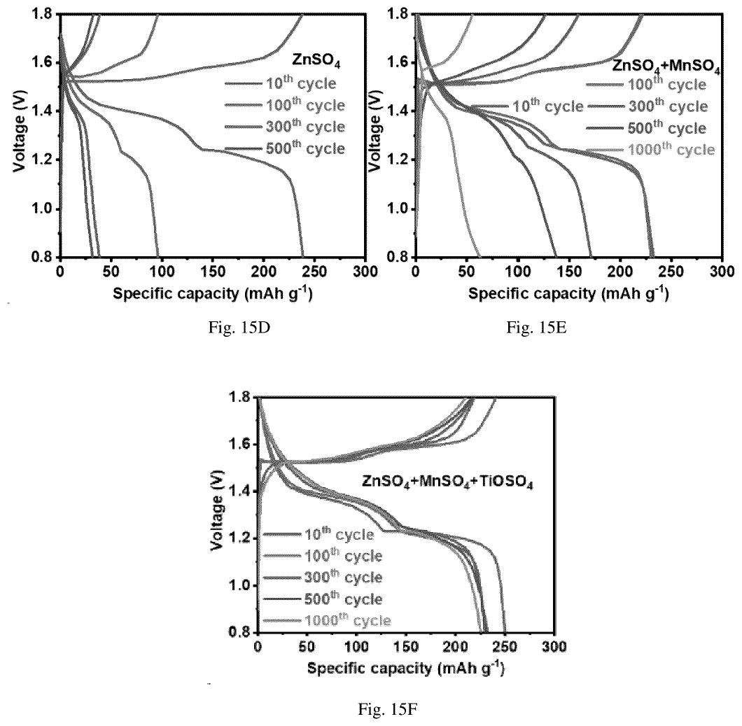

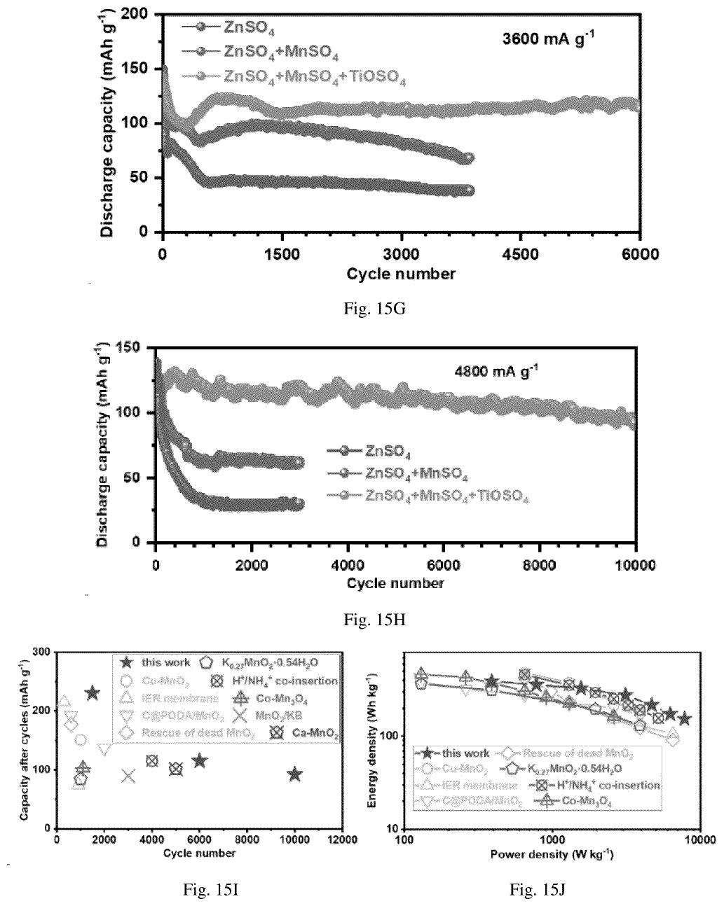

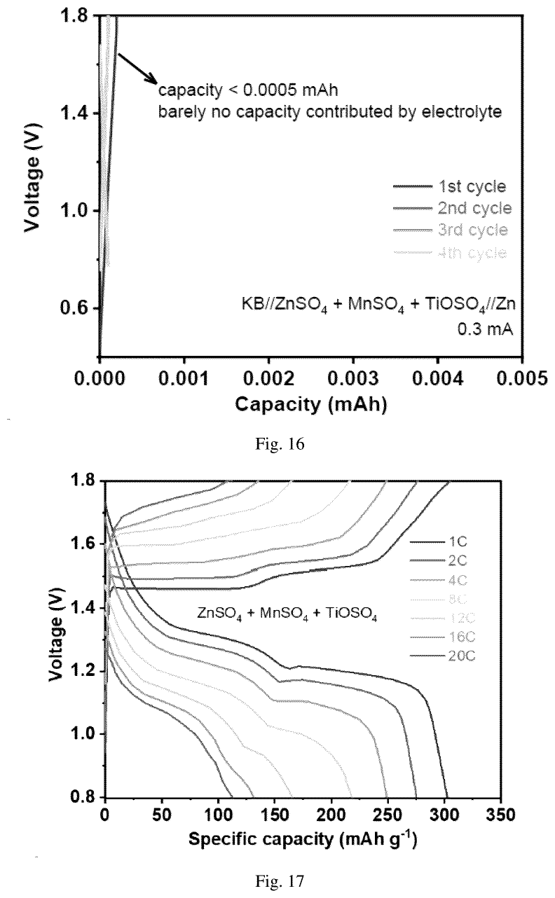

To explore the benefits of TiOSO₄ addition, electrochemical performances of the EMD-Zn cells with different electrolytes are displayed in FIGS. 15A-15J. CV curve of the cell using 1Zn+0.1Mn+0.5Ti electrolyte exhibits two distinctive redox peaks, which are also observed in cells with 1M ZnSO₄ and 1Zn+0.1Mn electrolyte. The redox peaks are confirmed to be originated from the charge-discharge reactions of EMD, as negligible capacity is obtained from a bare KB cathode without EMD (FIG. 16). The CV results indicate that TiOSO₄ additive does not greatly affect the main redox reactions of EMD.

The rate performance of EMD tested in different electrolytes are shown in FIG. 15B. One can see that the addition of MnSO₄ additive into the electrolyte can enhance the rate performance of EMD. This is attributed to the improved kinetic of the re-deposition of Mn²⁺ during the charge process with higher content of Mn²⁺ in the electrolyte. Further addition of TiOSO₄ into the electrolyte, i.e. Ti-doping of EMD, does not have significant effect on the rate performance. Specifically, the EMD electrode tested with 1Zn+0.1Mn+0.5Ti electrolyte shows a capacity of 302 mAh g⁻¹, 275 mAh g⁻¹, 250 mAh g⁻¹, 212 mAh g⁻¹, 165 mAh g⁻¹, 136 mAh g⁻¹, 118 mAh g⁻¹ at a current rate of 1C, 2C, 4C, 8C, 12C, 16C, 20C, respectively (1C=300 mA g⁻¹). The corresponding voltage profiles are shown in FIG. 17.

The cycle performances of the cells under a current of 1200 mA g⁻¹ are shown in FIG. 15C. While EMD tested in 1M ZnSO₄ electrolyte shows a fast capacity decay, the cell with 1Zn+0.1Mn exhibits a better cycle stability with a slower capacity fading, in line with the observation of many other literatures. However, the capacity still suddenly drops after about 200 cycles. In comparison, the cell tested with 1Zn+0.1Mn+0.5Ti electrolyte shows significant improvement in cyclability. After 1500 cycles, it still exhibits a capacity of 230 mAh g⁻¹, corresponding to a capacity retention of about 100% comparing to the initial cycle capacity. The voltage profiles of the three cells at different cycle numbers are shown in FIG. 15D-F. Different from the drastic decay in capacity for the cells in 1M ZnSO₄ and 1Zn+0.1Mn, that tested in 1Zn+0.1Mn+0.5Ti exhibits overlapping discharge-charge curves over 1500 cycles. In addition, the cycle stability of EMD electrode with TiOSO₄ electrolyte additive is improved also under different current densities. As displayed in FIGS. 15G and 4H, the cell with 1Zn+0.1Mn+0.5Ti electrolyte can still obtain a capacity of 113 mAh g⁻¹ after 6000 cycles under 3600 mA g⁻¹ and 92 mAh g⁻¹ after 10000 cycles under 4800 mA g⁻¹, superior to those of the cell with 1Zn+0.1Mn (73 mAh g⁻¹ after 3500 cycles at 3600 mA g⁻¹ and 60 mAh g⁻¹ after 3000 cycles at 4800 mA g⁻¹). The cycling performance is also the best amongst recently reported MnO₂—Zn batteries, as summarized in FIG. 15I and Table S2. As shown in the Ragone plots (FIG. 15J), the MnO₂—Zn cell with 1Zn+0.1Mn+0.5Ti electrolyte delivers an energy density of 390 Wh kg⁻¹ at a power density of 390 W kg⁻¹ (calculated based on the mass of cathode active material), and still holds an energy density of 153 Wh kg⁻¹ when the power density is increased to 7800 W kg⁻¹, which is superior to most of the previously reported ZIBs.

TABLE S2
Cycle performance comparison with the recent literatures.

| | | Capacity | | |
|---|---|---|---|---|
| | Current rate | after cycles | Cycle | |
| Design | (A g⁻¹) | (mAh g⁻¹) | number | Reference |
| Cu—MnO₂ | 7 | 151 | 1000 | [1] |
| IER membrane | 1 | 215 | 300 | [2] |
| | 5 | 75 | 900 | |
| C@PODA/MnO₂ | 0.5 | 192 | 600 | [3] |
| | 2 | 137 | 2000 | |
| Recovered MnO₂ | 1 | 177 | 600 | [4] |
| K_{0.27}MnO₂•0.54H₂O | 3 | 84 | 1000 | |
| H⁺/NH₄⁺ co-insertion | 4 | 115 | 4000 | [6] |
| Co—Mn₃O₄ | 2 | 103 | 1100 | [7] |
| MnO₂/KB | 5 | 90 | 3000 | [8] |
| Ca—MnO₂ | 3.5 | 101 | 5000 | [9] |
| Bi₂O₃/MnO₂ | 1 | 190 | 1000 | [10] |
| | 1.5 | 230 | 1500 | |
| TiOSO₄ additive | 3.6 | 115 | 6000 | this work |
| | 4.8 | 92 | 10000 | |

### Example 2

In the following examples, different electrolytes including the base electrolyte (1M ZnSO₄+0.1M MnSO₄) with or without additives according to this application are used. EMD is used as the electrode material. The rechargeable manganese-zinc battery is prepared using the same method as described above.

Cycle performance is defined as the capacity of the manganese-zinc battery at the 200^{th} cycle over that at the 2^{nd} cycle at a current rate of 900 mA/g. The battery is cycled at 900 mA/g between 0.8 to 1.8 V. The capacity (in mAh) is obtained from the battery tester divided by the mass of EMD in cathode (in mg).

### CE-1: Base Electrolyte (1M ZnSO₄+0.1M MnSO₄) without Additive

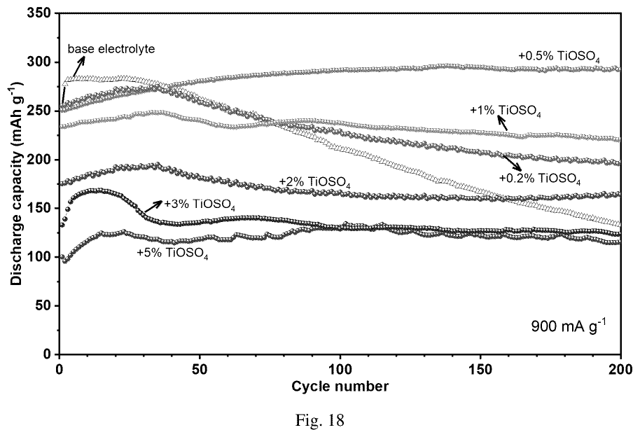

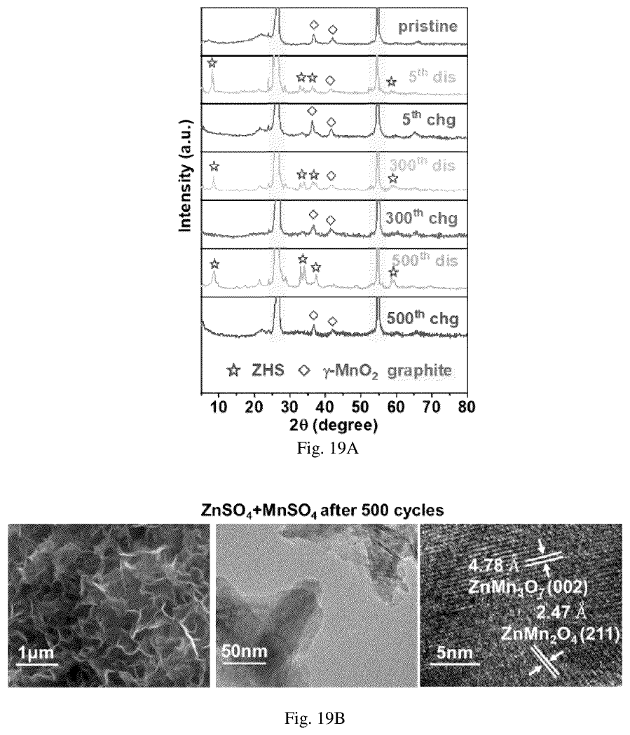

As shown in FIG. 18, the battery has a capacity of 277 mAh/g during the 2^{nd} cycle. However, its capacity is reduced to 133 mAh/g at the 200^{th} cycle, with a cycle performance of 48%.

### E2-1: Base Electrolyte (1M ZnSO₄+0.1M MnSO₄) with TiOSO₄ as Electrolyte Additive (Ti⁴⁺/TiO²⁺)

Electrodes and batteries are prepared the same way as CE-1, except that different amounts of TiOSO₄ are added into the 1M ZnSO₄+0.1M MnSO₄ base electrolyte. For example, “+0.5% (w/v) TiOSO₄” electrolyte means 0.5 g of TiOSO₄ is added in 100 ml of the base electrolyte and stirred overnight at room temperature. Therefore, the additive amounts in percentage herein, unless otherwise specified, refers to w/v percentages. The electrolytes with other additive amounts are prepared with the same method.

The capacity vs. cycle curves are shown in FIG. 18 and the cycle performances are summarized in Table 1. Cycle performance is improved with TiOSO₄ additive in the electrolyte, as it is increased from 48% without additive (CE-1) to 77.0% with +0.2% (w/v) TiOSO₄ (E2-la), to 116.8% with +0.5% (w/v) TiOSO₄ (E2-1b), and 93.2% with +2% (w/v) TiOSO₄ (E2-id). In particular, the battery with 0.5% (w/v) TiOSO₄ maintains a high capacity of 292 mAh g⁻¹ after 200 cycles.

In addition, the cycle performance can be improved to 115.0% with +5% (w/v) TiOSO₄ (E2-1f). However, it is further noted that the obtained capacity is reduced from the baseline level of 277 mAh/g to 100 mAh/g, which is smaller than the capacity of the baseline electrolyte without the electrolyte additive after 200 cycles. Therefore, in order to improve cycle performance without sacrificing the overall capacity of the battery, the additive percentage for the electrolyte is desired to be in a range from about 0.1% (w/v) to about 5% (w/v).

TABLE 1
Cycle performance comparison of electrolyte with
different amounts of TiOSO₄ electrolyte additive

| | | Capacity | Capacity | Cycle |
|---|---|---|---|---|
| | | of the | of the | performance |
| | | 2^{nd} cycle | 200^{th} cycle | (200^{th} cycle/ |
| | Electrolyte | (mAh/g) | (mAh/g) | 2^{nd} cycle) |
| Comparative | Base | 277 | 133 | 48.0% |
| Example 1 | electrolyte | | | |
| E2-1a | +0.2% (w/v) | 256 | 197 | 77.0% |
| | TiOSO₄ | | | |
| E2-1b | +0.5% (w/v) | 250 | 292 | 116.8% |
| | TiOSO₄ | | | |
| E2-1c | +1% (w/v) | 234 | 221 | 94.4% |
| | TiOSO₄ | | | |
| E2-1d | +2% (w/v) | 176 | 164 | 93.2% |
| | TiOSO₄ | | | |
| E2-1e | +3% (w/v) | 138 | 124 | 89.8% |
| | TiOSO₄ | | | |
| E2-1f | +5% (w/v) | 100 | 115 | 115.0% |
| | TiOSO₄ | | | |

Stability of EMD in fact may be influenced by the amount of TiOSO₄ additive. FIG. 18 shows the cycle performance of EMD in 1Zn+0.1Mn with different amounts of TiOSO₄. One can see that the addition of 0.2% (w/v) TiOSO₄ can reduce the capacity decay to some extent. Too much TiOSO₄ on the other hand reduces the overall capacity. These examples show that 0.5% (w/v) may be the optimal amount that gives a good balance between stability and capacity.

### Example 3

The rechargeable manganese-zinc battery is prepared in the same manner as Example 2.

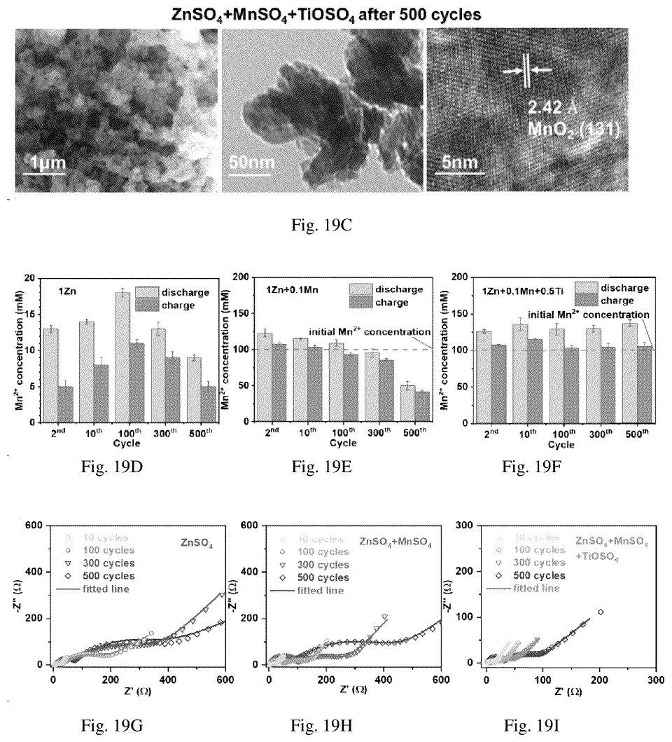

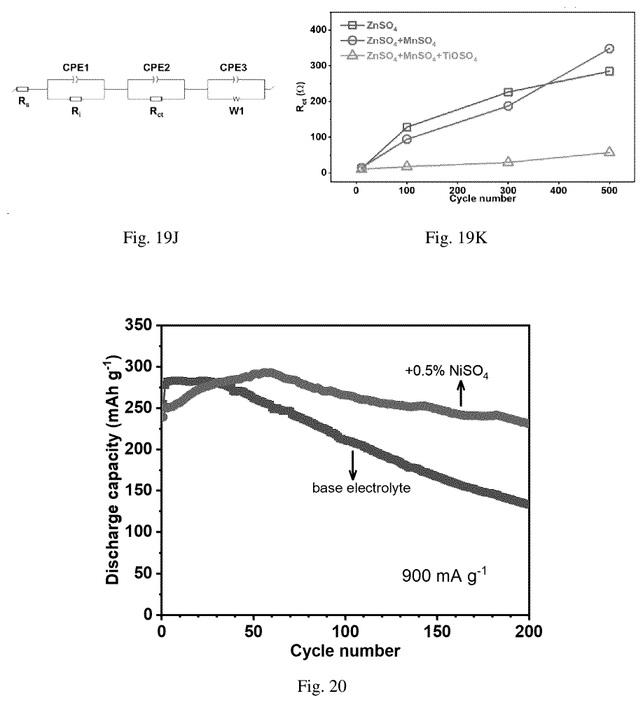

The effect of Ti additive on the structure of the EMD is further investigated by post-mortem tests, as shown in FIG. 5I and FIGS. 19A-19K.

To understand the reason for the improvement in cycle performance, XRD analyses of the MnO₂ electrodes from Example 2 are conducted after certain cycles (FIGS. 51 and 19A).

For the electrode cycled using base electrolyte (FIG. 5I), the initial EMD peaks turn into Zinc Hydroxide Sulfate (ZHS) peaks after the 5^{th} discharge, owing to the H⁺ consumption accompanied by H⁺ insertion and MnO₂ dissolution during discharge process, while after charging, the ZnMn₂O₄ peaks are found. After 300 cycles, the ZHS peaks under discharge state became weaker, and ZnMn₃O₇ peaks start to emerge. The ZnMn₂O₄ and ZnMn₃O₇ peaks are present under discharge and charge states, suggesting the irreversibility of these phases. After 500 cycles, the ZnMn₃O₇ peaks become stronger. Overall, with baseline electrolyte without additive, inactive ZnₓMn_{y}O phases may be formed, causing the capacity to be reduced with cycling.

In contrast, with the addition of 0.5% (w/v) TiOSO₄ (FIG. 19A), MnO₂ XRD peaks still can be observed under charge state even after 500 cycles, indicating that the additive can reduce ZnₓMn_{y}O phases and stabilize the MnO₂ structure, improving the cycle performance.

In FIG. 19A, the XRD patterns of the cell with 1Zn+0.1Mn+0.5Ti after different number of cycles are displayed. Different from the XRD pattern from the cell with 1Zn+0.1Mn in FIG. 5I, EMD peaks and ZHS peaks as observed at the charged and discharged states, respectively are well maintained for 500 cycles, and Zn-containing phases can hardly be observed. In addition, morphology changes of the electrodes after cycling are examined by SEM and TEM, as shown in FIG. 19B. After 500 cycles, the electrode tested in 1Zn+0.1Mn shows nanoflakes on its surface similar to that reported in previous literature. HRTEM image of the electrode show lattice fringes that are attributed to (002) from ZnMn₃O₇ and (211) from ZnMn₂O₄, which are consistent with the XRD peaks located at 18.5° and 36.4° in FIG. 5I. On the other hand, the electrode cycled in 1Zn+0.1Mn+0.5Ti electrolyte exhibits a nano particle morphology, in line with the observed morphologies of our electrodeposited material in FIGS. 8D and 8E—HRTEM image only shows long-range (131) lattice fringe of EMD. All the above results clearly demonstrate that TiOSO₄ addition suppresses the formation of Zn-containing phases and improves the reversibility of EMD.

### Example 4

The rechargeable manganese-zinc battery is prepared in the same manner as Example 2.

This example systematically monitors the changes in the Mn²⁺ concentration of the electrolytes over cycles via ICP analysis to better reveal the relationship between the Mn dissolution/deposition process and the electrochemical performance of EMD. In general, we observe that the Mn²⁺ concentration rises during discharging due to Mn dissolution while it falls during charging due to Mn deposition. Though, the overall amount of Mn²⁺ in the electrolyte can change with cycling. As shown in FIG. 19D, in a cell tested with 1M ZnSO₄ electrolyte without any additive, Mn²⁺ content in the electrolyte increases within the initial 100 cycles, indicating there is more Mn dissolution than Mn deposition. This is likely because there is no Mn+ in the electrolyte at the beginning, so some of the dissolved Mⁿ² stays in the electrolyte with cycling. After 100 cycles, the Mⁿ² concentrations of both discharged and charged states start to decline owing to the consumption of Mⁿ² from the irreversible formation of Zn-containing Mn oxide species.

The addition of 0.1M MnSO₄ into the electrolyte changes the overall trend of Mn²⁺ with cycling (FIG. 19E). The Mn²⁺ concentration rises and falls during discharge and charge, respectively, and the value remains around 0.1M during the initial cycles, indicating that the Mn²⁺ additive can effectively facilitate the re-deposition of Mn²⁺. Though, with further cycling, an irreversible consumption of Mn²⁺ occurs where Mn²⁺ content continues to decrease, and the formation of Zn—Mn—O still inevitably happens. It is noteworthy that the drastic decrease in Mn²⁺ content after 300 cycles is correlated with the abrupt capacity drop of the material in FIG. 15C. In contrast, with TiOSO₄ additive, the normal rise and fall in Mn²⁺ concentration during each cycle remains stable even after 500 cycles. Mn dissolution and deposition are reversible and there is no side reaction that consumes Mn with cycle. This is attributed to the effective suppression of Zn—Mn oxide deposition with the addition of TiOSO₄.

Apart from the depletion of active Mn in the electrolyte, the inactive Zn—Mn oxide formation also deteriorates the electrode. We measure the EIS of each cell with different cycles after charging and the Nyquist plots are displayed in FIGS. 19G-19I. The EIS profiles exhibit two semi-circles, which can be assigned to interface resistance Rᵢ and charge transfer resistance R_{ct} from higher to lower frequency, respectively. For all the three cells, the semi-circle representing R_{ct} increases with cycle number. The values of R_{ct} are obtained by fitting the curves with an equivalent circuit shown in FIG. 19J and the results are shown in FIG. 19K. Both cells tested with 1M ZnSO₄ and 1Zn+0.1Mn electrolyte exhibit drastic increase in R_{ct} increase to about 300Ω after 500 cycles. In contrast, the R_{ct} of the cell tested in 1Zn+0.1Mn+0.5Ti electrolyte only grows slightly to 57Ω after 500 cycles. This indicate that TiOSO₄ addition can suppress impedance growth of the electrode. Based on our previous discussion, the growing R_{ct} can be ascribed to the formation of inactive Zn—Mn oxides formation on the electrode which hinders the ion diffusion, and TiOSO₄ can impede such reaction.

### Example 5

In this example, additives different from TiOSO₄ are introduced into the electrolyte to test their effects on battery performances. The rechargeable manganese-zinc battery is prepared in the same manner as Example 2.

### E5-1: Base Electrolyte (1M ZnSO₄+0.1M MnSO₄) with NiSO₄ as Electrolyte Additive (Ni²⁺)

NiSO₄ can also be used as an effective electrolyte additive in this application. Electrodes and batteries are prepared the same way as CE-1 except that 0.5% (w/v) NiSO₄ is added into the 1M ZnSO₄+0.1M MnSO₄ base electrolyte.

The capacity vs. cycle curve of the manganese-zinc battery with +0.5% (w/v) NiSO₄ is shown in FIG. 20 and the cycle performance is summarized in Table 2. Under 900 mA g⁻¹, the battery with +0.5% (w/v) NiSO₄ electrolyte gives a capacity of 231 mAh g⁻¹ after 200 cycles with a cycle performance of 92.0%.

### E5-2: Base Electrolyte (1M ZnSO₄+0.1M MnSO₄) with La(NO₃)₃ as Electrolyte Additive (La³⁺)

Electrodes and batteries are prepared the same way as CE-1 except that 0.5% (w/v) La(NO₃)₃ is added into the 1M ZnSO₄+0.1M MnSO₄ base electrolyte.

The capacity vs. cycle curve of the manganese-zinc battery with +0.5% (w/v) La(NO₃)₃ is shown in FIG. 21 and the cycle performance is summarized in Table 2. Under 900 mA g⁻¹, the battery with +0.5% (w/v) La(NO₃)₃ electrolyte gives a capacity of 172 mAh g⁻¹ after 200 cycles with a cycle performance of 61.6%.

### E5-3: Base Electrolyte (1M ZnSO₄+0.1M MnSO₄) with FeSO₄ and Fe₂(SO₄)₃ as Electrolyte Additive (Fe²⁺ and Fe³⁺)

Electrodes and batteries are prepared the same way as CE-1 except that 0.5% (w/v) FeSO₄/0.5% (w/v) Fe₂(SO₄)₃ is added into the 1M ZnSO₄+0.1M MnSO₄ base electrolyte.

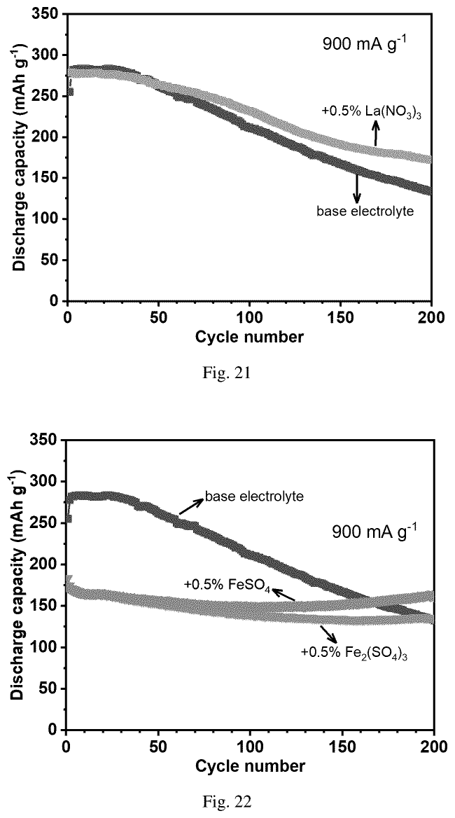

The capacity vs. cycle curves of the manganese-zinc batteries with +0.5% (w/v) FeSO₄ (E5-3a) and +0.5% (w/v) Fe₂(SO₄)₃(E5-3b) are shown in FIG. 22 and the cycle performances are summarized in Table 2. Under 900 mA g⁻¹, the battery with +0.5% (w/v) FeSO₄ and +0.5% (w/v) Fe₂(SO₄)₃ electrolyte gives a capacity of 161 and 150 mAh g⁻¹, respectively after 200 cycles with a cycle performance of 94.7% and 86.2%, respectively.

### E5-4: Base Electrolyte (1M ZnSO₄+0.1M MnSO₄) with H₃BO₃ as Electrolyte Additive

Electrodes and batteries are prepared the same way as CE-1 except that 0.5% (w/v) H₃BO₃ is added into the 1M ZnSO₄+0.1M MnSO₄ base electrolyte.

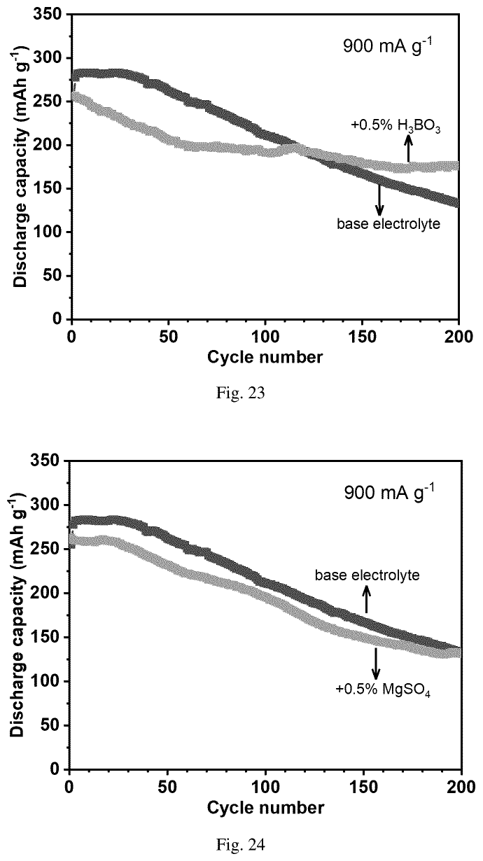

The capacity vs. cycle curves of the manganese-zinc batteries with +0.5% (w/v) H₃BO₃ (E5-4) are shown in FIG. 23 and the cycle performances are summarized in Table 2. Under 900 mA g⁻¹, the battery with +0.5% (w/v) H₃BO₃ electrolyte gives a capacity of 177 mAh g⁻¹ after 200 cycles with a cycle performance of 69.1%.

### E5-5: Base Electrolyte 2ⁿM ZnSO₄+0.1M MnSO₄) with MgSO₄ as Electrolyte Additive

Electrodes and batteries are prepared the same way as CE-1 except that 0.5% (w/v) MgSO₄ is added into the 1M ZnSO₄+0.1M MnSO₄ base electrolyte.

The capacity vs. cycle curves of the manganese-zinc batteries with +0.5% MgSO₄ (E5-5) are shown in FIG. 24 and the cycle performances are summarized in Table 2. Under 900 mA g, the battery with +0.5% (w/v) MgSO₄ electrolyte gives a capacity of 131 mAh g⁻¹ after 200 cycles with a cycle performance of 50.2%.

TABLE 2
Cycle performance comparison of electrolyte
with different kinds of electrolyte additives

| | | Capacity | Capacity | Cycle |
|---|---|---|---|---|
| | | of the | of the | performance |
| | | 2^{nd} cycle | 200^{th} cycle | (200^{th} cycle/ |
| | electrolyte | (mAh/g) | (mAh/g) | 2^{nd} cycle) |
| CE-1 | Base | 277 | 133 | 48.0% |
| | electrolyte | | | |
| E2- 1b | +0.5% (w/v) | 250 | 292 | 116.8% |
| | TiOSO₄ | | | |
| E5-1 | +0.5% (w/v) | 251 | 231 | 92.0% |
| | NiSO₄ | | | |
| E5-2 | +0.5% (w/v) | 279 | 172 | 61.6% |
| | La(NO₃)₃ | | | |
| E5-3a | +0.5% (w/v) | 170 | 161 | 94.7% |
| | FeSO₄ | | | |
| E5-3b | +0.5% (w/v) | 174 | 150 | 86.2% |
| | Fe2(SO₄)₃ | | | |
| E5-4 | +0.5% (w/v) | 256 | 177 | 69.1% |
| | H3BO₃ | | | |
| E5-5 | +0.5% (w/v) | 260 | 131 | 50.2% |
| | MgSO₄ | | | |

### Example 6

In the following examples, different electrode materials are used. The electrolyte and the rechargeable manganese-zinc battery is prepared using the same method as described above.

### Comparative Example 2 (CE-2): Mn₂O₃ as Electrode Material without Electrolyte Additive

Electrode with Mn₂O₃, ketjen black and PVdF binder in a weight ratio of 7:2:1 is coated on graphite paper as cathode, Zn foil (50 μm) as anode to form the rechargeable manganese-zinc battery. Mn₂O₃ is made by annealing the EMD powder (Xiangtan Electrochemical Scientific ltd, China) at 550° C. for 5 h. 1M ZnSO₄+0.1M MnSO₄ is used as the electrolyte and the battery is cycled at 900 mA/g between 0.8 to 1.8 V.

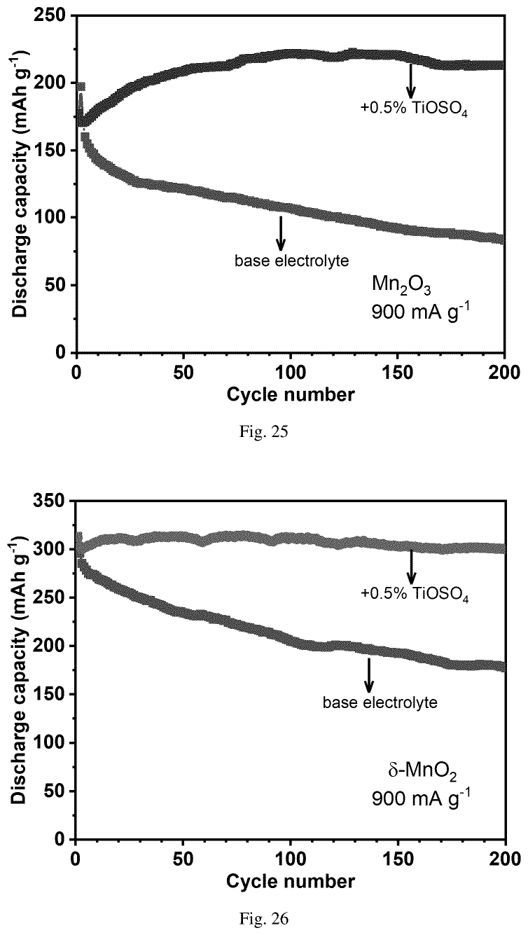

As shown in FIG. 25, the battery has a capacity of 197 mAh/g during the 2^{nd} cycle. 5 However, its capacity is reduced to 83 mAh/g at the 200^{th} cycle, with a cycle performance of 42.1%.

### E6-1: Mn₂O₃ as Electrode Material with Electrolyte Additive

Electrodes and batteries are prepared the same way as CE-2 except that 0.5% (w/v) TiOSO₄ is added into the 1M ZnSO₄+0.1M MnSO₄ base electrolyte.

The capacity vs. cycle curves of the manganese-zinc batteries with +0.5% (w/v) TiOSO₄ are shown in FIG. 25 and the cycle performances are summarized in Table 3. Under 900 mA g⁻¹, the battery with +0.5% TiOSO₄ electrolyte gives a capacity of 212 mAh g⁻¹ after 200 cycles with a cycle performance of 124.7%.

TABLE 3
Cycle performance comparison of batteries including Mn₂O₃ in cathode
and containing electrolyte with or without electrolyte additives

| | | Capacity | Capacity | Cycle |
|---|---|---|---|---|
| | | of the | of the | performance |
| | | 2^{nd} cycle | 200^{th} cycle | (200^{th} cycle/ |
| Mn₂O₃ | electrolyte | (mAh/g) | (mAh/g) | 2^{nd} cycle) |
| CE- 2 | Base | 197 | 83 | 42.1% |
| | electrolyte | | | |
| E6-1 | +0.5% (w/v) | 170 | 212 | 124.7% |
| | TiOSO₄ | | | |

### Comparative Example 3 (CE-3): δ-MnO₂ as Electrode Material without Electrolyte Additive

δ-MnO₂ is synthesized through the following method: At room temperature, 3.4 g of MnSO₄·H₂O powder is dissolved in 20 mL of distilled water, and then 30 mL of NaOH (6 M) aqueous solution is added dropwise into the solution under vigorous stirring, obtaining a light brown slurry of Mn(OH)₂. After stirring for approximately 1 h, 3.2 g of (NH₄)₂S₂O₈ granular mixture is slowly added into the slurry, and an olive green powder of Na birnessite (δ-MnO₂) is extracted from the slurry.

Electrode with δ-MnO₂, ketjen black and PVdF binder in a weight ratio of 7:2:1 is coated on graphite paper as cathode, Zn foil (50 m) as anode to form the rechargeable manganese-zinc battery. 1M ZnSO₄+0.1M MnSO₄ is used as the electrolyte and the battery is cycled at 900 mA/g between 0.8 to 1.8 V.

As shown in FIG. 26, the battery has a capacity of 296 mAh/g during the 2^{nd} cycle. However, its capacity is reduced to 177 mAh/g at the 200^{th} cycle, with a cycle performance of 59.8%.

### E6-2: δ-MnO₂ as Electrode Material with Electrolyte Additive

Electrodes and batteries are prepared the same way as CE-3 except that 0.5% (w/v) TiOSO₄ is added into the 1M ZnSO₄+0.1M MnSO₄ base electrolyte.

The capacity vs. cycle curves of the manganese-zinc batteries with +0.5% (w/v) TiOSO₄ are shown in FIG. 26 and the cycle performances are summarized in Table 4. Under 900 mA g⁻¹, the battery with +0.5% (w/v) TiOSO₄ electrolyte gives a capacity of 300 mAh g⁻¹ after 200 cycles with a cycle performance of 99.0%.

TABLE 4
Cycle performance comparison of batteries including
δ - MnO₂ in cathode and containing electrolyte
with or without electrolyte additives

| | | Capacity | Capacity | Cycle |
|---|---|---|---|---|
| | | of the | of the | performance |
| | | 2^{nd} cycle | 200^{th} cycle | (200^{th} cycle/ |
| δ - MnO² | electrolyte | (mAh/g) | (mAh/g) | 2^{nd} cycle) |
| CE-3 | Base | 296 | 177 | 59.8% |
| | electrolyte | | | |
| E6-2 | +0.5% (w/v) | 303 | 300 | 99.0% |
| | TiOSO₄ | | | |

### Comparative Example 4 (CE-4): β-MnO₂ as Electrode Material without Electrolyte Additive

Electrode with β-MnO₂ (Alfa Aesar, USA), ketjen black and PVdF binder in a weight ratio of 7:2:1 is coated on graphite paper as cathode, Zn foil (50 m) as anode to form the rechargeable manganese-zinc battery. 1M ZnSO₄+0.1M MnSO₄ is used as the electrolyte and the battery is cycled at 900 mA/g between 0.8 to 1.8 V.

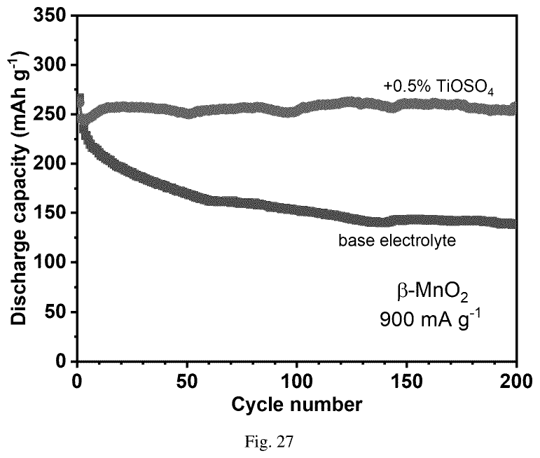

As shown in FIG. 27, the battery has a capacity of 246 mAh/g during the 2^{nd} cycle. However, its capacity is reduced to 138 mAh/g at the 200^{th} cycle, with a cycle performance of 56.1%.

### E6-3: β-MnO₂ as Electrode Material and Base Electrolyte with 0.5% (w/v) TiOSO₄

Electrodes and batteries are prepared the same way as Comparative Example 4 except that 0.5% (w/v) TiOSO₄ is added into the 1M ZnSO₄+0.1M MnSO₄ base electrolyte.

The capacity vs. cycle curves of the manganese-zinc batteries with +0.5% (w/v) TiOSO₄ are shown in FIG. 27 and the cycle performances are summarized in Table 4. Under 900 mA g⁻¹, the battery with +0.5% TiOSO₄ electrolyte gives a capacity of 258 mAh g⁻¹ after 200 cycles with a cycle performance of 104.8%.

TABLE 5
Cycle performance comparison of batteries including
β- MnO₂ in cathode and containing electrolyte
with or without electrolyte additives

| | | Capacity | Capacity | Cycle |
|---|---|---|---|---|
| | | of the | of the | performance |
| | | 2^{nd} cycle | 200^{th} cycle | (200^{th} cycle/ |
| β- MnO₂ | electrolyte | (mAh/g) | (mAh/g) | 2^{nd} cycle) |
| CE- 4 | Base | 246 | 138 | 56.1% |
| | electrolyte | | | |
| E6-3 | +0.5% | 246 | 258 | 104.8% |
| | TiOSO₄ | | | |

It is believed that the present application can greatly improve the cycle performance of the aqueous rechargeable manganese-zinc battery system, which can promote its application. The manganese-zinc battery employs aqueous electrolyte, featuring low cost, intrinsic safety, and moderate energy density. It is a new type of rechargeable battery that can replace lead-acid batteries widely used in the automobile applications. Also, the rechargeable manganese-zinc battery can be used for grid-scale energy storage, such as power plants, renewable energy storage, etc. and also replace single-use primary alkaline batteries.

Lead-acid battery is the main technology/product on the market for aqueous-based battery. Lead-acid batteries are commonly used in automobile applications while causing serious environmental concerns for the toxicity of lead. In the rechargeable manganese-zinc battery, both the electrodes are safe and non-toxic. Especially, the cost of the electrode materials are low (the price of Zn metal is below US$3000/ton (London Metal Exchange), whereas that of MnO₂ is about $1000/ton (from a survey in Alibaba)), giving an estimate cost of the manganese-zinc full battery to be ˜US$23/kWh, much lower than that of lead-acid batteries (˜US$70/kWh) and lithium-ion batteries (˜US$200/kWh). In addition, the mature process used to manufacture alkaline MnO₂—Zn batteries can be directly transferred to the preparation of rechargeable manganese-zinc batteries. In addition, our rechargeable manganese-zinc batteries are demonstrated with excellent stability that potentially surpass the performances of lead-acid batteries. Furthermore, the theoretical energy density of lead-acid battery is 167 Wh/kg (practice energy density of 30-40 Wh/kg) considering just the electrode and electrolyte, while the theoretical energy density of rechargeable manganese-zinc battery is 209 Wh/kg. Considering other components in the battery, practical energy density of rechargeable manganese-zinc battery would be around 40-50 Wh/kg, higher than that of lead-acid batteries.

Overall, the rechargeable manganese-zinc battery that can be made using our application will have lower cost and higher energy density than lead-acid batteries used on the market.

It should be understood that the above only illustrates and describes examples whereby the present application may be carried out, and that modifications and/or alterations may be made thereto without departing from the spirit of the application.

It should also be understood that certain features of the present application, which are, for clarity, described in the context of separate embodiments, may also be provided in combination in a single embodiment. Conversely, various features of the present application which are, for brevity, described in the context of a single embodiment, may also be provided separately, or in any suitable subcombination.

### REFERENCES

[1] J. Zhang, W. Li, J. Wang, X. Pu, G. Zhang, S. Wang, N. Wang, X. Li, Engineering p-Band Center of Oxygen Boosting H⁺ Intercalation in δ-MnO₂ for Aqueous Zinc Ion Batteries, Angewandte Chemie International Edition. 62 (2023) e202215654.
[2] Y Wu, J. Zhi, M. Han, Z. Liu, Q. Shi, Y Liu, P. Chen, Regulating proton distribution by ion exchange resin to achieve long lifespan aqueous Zn—MnO₂ battery, Energy Storage Materials. 51 (2022) 599-609.
[3] Y Zhao, R. Zhou, Z. Song, X. Zhang, T. Zhang, A. Zhou, F. Wu, R. Chen, L. Li, Interfacial Designing of MnO₂ Half-Wrapped by Aromatic Polymers for High-Performance Aqueous Zinc-Ion Batteries, Angewandte Chemie International Edition. 61 (2022) e202212231.
[4] H. Yang, W. Zhou, D. Chen, J. Liu, Z. Yuan, M. Lu, L. Shen, V. Shulga, W. Han, D. Chao, The origin of capacity fluctuation and rescue of dead Mn-based Zn-ion batteries: a Mn-based competitive capacity evolution protocol, Energy & Environmental Science. 15 (2022) 1106-1118.
[5] L. Liu, Y—C. Wu, L. Huang, K. Liu, B. Duployer, P. Rozier, P.-L. Taberna, P. Simon, Alkali ions pre-intercalated layered MnO₂ nanosheet for zinc-ions storage, Advanced Energy Materials. 11 (2021) 2101287.
[6] S. Wang, Z. Yuan, X. Zhang, S. Bi, Z. Zhou, J. Tian, Q. Zhang, Z. Niu, Non-metal ion co-insertion chemistry in aqueous Zn/MnO₂ batteries, Angewandte Chemie. 133 (2021) 7132-7136.
[7] J. Ji, H. Wan, B. Zhang, C. Wang, Y Gan, Q. Tan, N. Wang, J. Yao, Z. Zheng, P. Liang, J. Zhang, H. Wang, L. Tao, Y Wang, D. Chao, H. Wang, Co^{2+/3+/4+}-regulated electron state of Mn—O for superb aqueous zinc-manganese oxide batteries, Advanced Energy Materials. 11 (2021) 2003203.
[8] X. Yang, Z. Jia, W. Wu, H.-Y Shi, Z. Lin, C. Li, X.-X. Liu, X. Sun, The back-deposition of dissolved Mn²⁺ to MnO₂ cathodes for stable cycling in aqueous zinc batteries, Chemical Communications. 58 (2022) 4845-4848.
[9] T. Sun, Q. Nian, S. Zheng, J. Shi, Z. Tao, Layered Ca_{0.28}MnO₂·0.5H₂O as a high performance cathode for aqueous zinc-ion battery, Small. 16 (2020) 2000597.
[10] Q. Duan, Y Wang, S. Dong, D. Y W. Yu, Facile electrode additive stabilizes structure of electrolytic MnO₂ for mild aqueous rechargeable zinc-ion battery, Journal of Power Sources. 528 (2022) 231194.

All references specifically cited herein are hereby incorporated by reference in their entireties. However, the citation or incorporation of such a reference is not necessarily an admission as to its appropriateness, citability, and/or availability as prior art to/against the present application.

What is claimed is:

1. An electrolyte for a battery comprising a manganese-based cathode, the electrolyte further comprising a metal/metalloid ion of the formula Mⁿ⁺ where M indicates a metal/metalloid and wherein n is from about 2 to about 4.

2. The electrolyte of claim 1, wherein the metal/metalloid ion is selected from the group consisting of Ti⁴⁺, TiO²⁺, Ni²⁺, Fe²⁺, Fe³⁺, La³⁺, Zr⁴⁺, ZrO²⁺, Sn²⁺, Bi³⁺, V⁴⁺, V³⁺, V²⁺, Al³⁺, Sb³⁺, Mg²⁺, Ca²⁺, B³⁺, and a combination thereof.

3. The electrolyte of claim 1, wherein the metal/metalloid ion is present in the form of salt selected from the group consisting of TiOSO₄, NiSO₄, La(NO₃)₃, FeSO₄, Fe₂(SO₄)₃, H₃BO₃, MgSO₄, and a combination thereof.

4. The electrolyte of claim 1, wherein the amount of Mnⁿ⁺ is in a range from about 0.1% (w/v) to about 5% (w/v).

5. The electrolyte of claim 1, wherein the metal/metalloid ion is served as an in-situ doping source to form a metal/metalloid-doped manganese-based cathode during a charge/discharge process of the battery.

6. A battery comprising a manganese-based cathode, comprising an electrolyte comprising a metal/metalloid ion of the formula Mⁿ⁺ where M indicates a metal/metalloid and wherein n is from about 2 to about 4.

7. The battery of claim 6, wherein the metal/metalloid ion is selected from the group consisting of Ti⁴⁺, TiO²⁺, Ni²⁺, Fe²⁺, Fe³⁺, La³⁺, Zr⁴⁺, ZrO²⁺, Sn²⁺, Bi³⁺, V⁴⁺, V³⁺, V²⁺, Al³⁺, Sb³⁺, Mg²⁺, Ca²⁺, B³⁺, and a combination thereof.

8. The battery of claim 6, wherein the metal/metalloid ion is present in the form of salt selected from the group consisting of TiOSO₄, NiSO₄, La(NO₃)₃, FeSO₄, Fe₂(SO₄)₃, H₃BO₃, MgSO₄, and combinations thereof.

9. The battery of claim 6, wherein the electrolyte comprises from about 0.05% (w/v) to about 10% (w/v); or from about 0.1% (w/v) to about 5% (w/v), metal/metalloid ion.

10. The battery of claim 6, wherein a metal/metalloid-doped manganese-based cathode is formed via in-situ doping during a charge/discharge process of the battery.

11. The battery of claim 6, wherein the manganese-based cathode comprises a cathode material selected from the group consisting of MnO₂, MnO, Mn₃O₄, Mn₂O₃, MnOOH, and a combination thereof.

12. The battery of claim 11, wherein the cathode material is MnO₂.

13. The battery of claim 12, wherein MnO₂ comprises different polymorphs selected from the group consisting of α, β, γ, δ, λ, Ramsdellite and electrolytic manganese dioxide structures.

14. The battery of claim 6, wherein the manganese-based cathode comprises a metal/metalloid doped structure in the cathode after charge/discharge cycles, which prevents the manganese-based cathode from transforming into electrochemically inert phases.

15. The battery of claim 6, wherein the battery comprises an anode, which comprises materials selected from the group consisting of Zinc, Zinc alloys, and a combination thereof.

16. The battery of claim 6, wherein the battery comprises an anode-less battery, wherein zinc is deposited on Cu or carbon.

17. A method for improving performance of a battery comprising a manganese-based cathode comprising introducing a metal/metalloid ion of the formula Mⁿ⁺ where M indicates a metal/metalloid and wherein n is from about 2 to about 4 into an electrolyte.

18. The method according to claim 17, wherein the metal/metalloid ion is selected from the group consisting of Ti⁴⁺, TiO²⁺, Ni²⁺, Fe²⁺, Fe³⁺, La³⁺, Zr⁴⁺, ZrO²⁺, Sn²⁺, Bi³⁺, V⁴⁺, V³⁺, V²⁺, Al³⁺, Sb³⁺, Mg²⁺, Ca²⁺, B³⁺, and a combination thereof.

19. The method of claim 17, wherein the metal/metalloid ion is present in the form of salt selected from the group consisting of TiOSO₄, NiSO₄, La(NO₃)₃, FeSO₄, Fe₂(SO₄)₃, H₃BO₃, MgSO₄, and combinations thereof.

20. The method of claim 17, wherein the electrolyte comprises from about 0.05% (w/v) to about 10% (w/v); or from about 0.1% (w/v) to about 5% (w/v), metal/metalloid ion.

21. The method of claim 17, wherein the battery is charged and discharged to form a metal/metalloid-doped manganese-based cathode via in-situ doping with the metal/metalloid ion.
